(19) United States
(12) Patent Application Publication
(10) Pub. No.: US 2023/0292744 A1
(43) Pub. Date: Sep. 21, 2023

(54) FLYING PEST CONTROL COMPOSITION AND FLYING PEST CONTROL SPRAY

(71) Applicant: Kao Corporation, Chuo-ku, Tokyo (JP)

(72) Inventors: Kazuma Saito, Sumida-ku, Tokyo (JP); Masahiro SUZUKI, Sumida-ku, Tokyo (JP); Kouhei TAKEUCHI, Sumida-ku, Tokyo (JP)

(73) Assignee: Kao Corporation, Chuo-ku, Tokyo (JP)

(21) Appl. No.: 17/642,829

(22) PCT Filed: Sep. 15, 2020
(86) PCT No.: PCT/JP2020/034902

§ 371 Date: Mar. 14, 2022

(30) Foreign Application Priority Data
Sep. 17, 2019 (JP) 2019-168681

(51) Int. Cl. A01N 25/06; A01M 29/12; A01N 25/30; A01N 31/02; A01N 43/16; A01N 33/12

(52) U.S. Cl. CPC A01N 25/06; A01M 29/12; A01N 25/30; A01N 31/02; A01N 43/16; A01N 33/12

(57) ABSTRACT

A flying pest exterminating composition containing 0.01% by mass or more and 3.0% by mass or less of a wing wetting agent having a surface tension at 25° C. of 27.0 mN/m or more and 50.0 mN/m or less as a 3 mmol/kg aqueous solution, the composition being used by being sprayed in the form of droplets having an average particle diameter of 20 μm or more and 400 μm or less.

### FIELD OF THE INVENTION

The present invention relates to a flying pest exterminating composition and a flying pest exterminating spray.

### BACKGROUND OF THE INVENTION

Pests, for example, flying pests, such as mosquitoes and flies, carry pathogens to animals, such as humans, and are factors that cause infectious diseases and dermatitis. In particular, some mosquitoes are hygienically very harmful insects because they carry pathogens, such as dengue fever, Zika fever, yellow fever, encephalitis, and malaria.

Conventionally, in order to protect themselves from such flying pests, a method of spraying an insecticide, a method of applying a pest repellent onto the skin surface, and so on have been widely used.

However, in insecticidal components contained in insecticides and pest repellent components contained in pest repellents, there is a concern to safety for a human body. In particular, it is desired to apply a highly safe insecticide or pest repellent to young children who always get bitten by mosquitoes.

In addition, conventionally, it has been studied to prevent insect bite and sting mainly outdoors. However, according to recent researches, it has become clear that the frequency of mosquito bite even indoors is equal to or higher than that outdoors. Then, a proposal for defending oneself from flying pests even indoors is desired.

With respect to a method of capturing and exterminating flying insects without using an insecticidal component, for example, PTL 1 (JP 2004-180635 A) discloses a method of capturing flying pests, such as flies, by spraying ethyl alcohol or a liquid containing ethyl alcohol on the flying pests to prevent them from flying.

PTL 2 (JP 2012-97004 A) discloses that a pest exterminator and a pest extermination preparation, each of which is an aqueous liquid containing a (meth)acrylic acid alkyl ester copolymer having film formability and a surfactant, exhibit a pest extermination effect even without containing an insecticidal component.

### SUMMARY OF THE INVENTION

The present invention provides the following [1] to [4].
[1] A flying pest exterminating composition containing 0.01% by mass or more and 3.0% by mass or less of a wing wetting agent having a surface tension at 25° C. of 27.0 mN/m or more and 50.0 mN/m or less as a 3 mmol/kg aqueous solution, the composition being used by being sprayed in the form of droplets having an average particle diameter of 20 μm or more and 400 μm or less.
[2] A flying pest exterminating composition containing 0.01% by mass or more and 3.0% by mass or less of a wing wetting agent, the composition being used by being sprayed in the form of droplets having an average particle diameter of 20 μm or more and 400 μm or less and having a surface tension at 25° C. of 27.0 mN/m or more and 50.0 mN/m or less.
[3] A flying pest exterminating spray including a flying pest exterminating composition filled in a spray container, wherein the composition contains 0.01% by mass or more and 3.0% by mass or less of a wing wetting agent having a surface tension at 25° C. of 27.0 mN/m or more and 50.0 mN/m or less as a 3 mmol/kg aqueous solution, the composition being used by being sprayed in the form of droplets having an average particle diameter of 20 μm or more and 400 μm or less.
[4] A flying pest exterminating spray including a flying pest exterminating composition filled in a spray container, wherein the composition has a surface tension at 25° C. of 27.0 mN/m or more and 50.0 mN/m or less and contains 0.01% by mass or more and 3.0% by mass or less of a wing wetting agent, the composition being used by being sprayed in the form of droplets having an average particle diameter of 20 μm or more and 400 μm or less.

### BRIEF DESCRIPTION OF THE DRAWING

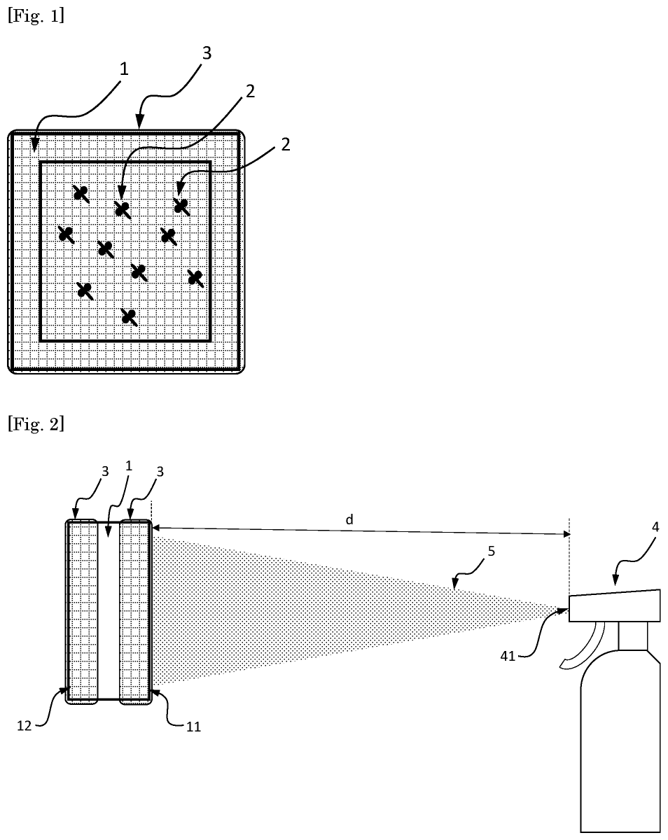

“FIG. 1” is an explanatory view of an evaluation method of the number of dropped mosquitoes and is a planar schematic view of a frame (1) used for the evaluation, in which mosquitoes are enclosed.

“FIG. 2” is an explanatory view of the evaluation method of the number of dropped mosquitoes and is a schematic view in which the state of spraying a flying pest exterminating composition within the frame (1) is seen from the side face direction of the frame (1).

### DETAILED DESCRIPTION OF THE INVENTION

### [Flying Pest Exterminating Composition]

The flying pest exterminating composition according to a first embodiment of the present invention is a flying pest exterminating composition containing 0.01% by mass or more and 3.0% by mass or less of a wing wetting agent having a surface tension at 25° C. of 27.0 mN/m or more and 50.0 mN/m or less as a 3 mmol/kg aqueous solution, the composition being used by being sprayed in the form of droplets having an average particle diameter of 20 μm or more and 400 μm or less.

The flying pest exterminating composition according to a second embodiment of the present invention is a flying pest exterminating composition containing 0.01% by mass or more and 3.0% by mass or less of a wing wetting agent, the composition being used by being sprayed in the form of droplets having an average particle diameter of 20 μm or more and 400 μm or less and having a surface tension at 25° C. of 27.0 mN/m or more and 50.0 mN/m or less.

The aforementioned flying pest exterminating compositions according to the aforementioned first and second embodiments are also hereinafter named generically as “composition of the present invention” unless otherwise specifically noted.

The flying pest exterminating composition of the present invention is one having a function to make contact with wings of a flying pest to lower a flying ability and suppress flying of the flying pest and detoxifying the flying pest through a mechanism of action, such as preventing the flying pest from flying and dropping a flying pest during flying or landing on the wall or the like on the ground, thereby exhibiting an effect for exterminating the flying pest.

PTL 1 describes that ethyl alcohol itself or, for example, a liquid prepared by diluting 70% by weight of ethyl alcohol with 30% by weight of water is sprayed on flying pests. However, from the viewpoint of environmental safety, it may not be said that the method of spraying a liquid containing a large quantity of ethyl alcohol that is a combustible organic solvent is a preferred method.

The pest exterminator of PTL 2 is one which by containing the (meth)acrylic acid alkyl ester copolymer having film formability, lowers flexibility of wings of a flying pest during spraying on the flying pest, loses the flying ability, or forms a film capable of blocking the spiracles or trachea to suffocate the pest, thereby exhibiting an effect for exterminating the flying pest. However, in view of the fact the pest exterminator of the type of spraying on flying pests is required to be adjusted to a viscosity suitable for spraying, the addition amount of a polymer that is an active ingredient as the pest exterminator is substantially restricted.

In addition, in order to enhance the extermination effect, the pest exterminator of the type of spraying on flying pests is also required to have a performance such that even when sprayed on flying pests from a place with a certain distance or more, the sprayed droplets of the pest exterminator go straight without scattering vertically and horizontally and efficiently reach the flying pest. The details of such a performance are not studied in PTLs 1 and 2.

An object of the present invention is to provide a flying pest exterminating composition which is used by spraying on flying pests, the composition having high safety for the human body and the environment, is able to efficiently make sprayed droplets reach the flying pests, and has a high extermination effect.

The present inventors have found that in the flying pest exterminating composition which is used by spraying on flying pests, by allowing the composition to contain a specified amount of a wetting agent capable of wetting wings of a flying pest, when sprayed on a flying pest, a flying ability of the flying pest is lowered, and according to this action, the flying pest can be effectively exterminated even without daring to use an insecticidal component. Furthermore, they have been found that in the foregoing composition, by setting the average particle diameter of the sprayed droplets to a specified range, when sprayed on the flying pest, the straightness of the sprayed droplets is enhanced to enable the droplets to efficiently reach the flying pest, thereby making it possible to improve the extermination effect of the flying pest.

In the present invention, what the flying ability of the flying pest is lowered indicates that the flying pest becomes impossible to fly. In addition, in the present invention, what the flying pest is exterminated indicates that a flying pest is detoxified against animals, such as humans, through a mechanism of action, such as preventing the flying pest from flying, shooting down a flying pest during flying to drop on the ground, or dropping a flying pest landing on the wall or the like on the ground.

In accordance with the present invention, it is possible to provide a flying pest exterminating composition and a flying pest exterminating spray, each of which has high safety for the human body and the environment and lowers the flying ability of the flying pest by spraying on the flying pest, thereby making it possible to efficiently exterminate the flying pest.

In the present invention, the “flying pests” refer to pests that approach animals, such as humans, while flying and suck blood from their skins, pests that carry pathogenic bacteria or the like while flying even without sucking blood, and pests in which their own flying gives a feeling of displeasure to humans.

Specific examples of the flying pests include mosquitoes, such as Anopheles sinensis, Culex pipiens pallens, Culex tritaeniorhynchus, Aedes aegypti, Culex pipiens molestus, Aedes albopictus, Aedes togoi, Anopheles gambiae, and Anopheles stephensi; chironomidae, such as Chironomus yoshimatsui and Propsilocerus akamusi; black flies, such as Twinnia japonensis, Prosimulium yezoense, and Odagmia aokii; flies, such as Musca domestica, Muscina stabulans, Fannia canicularis, Calliphoridae, Sarcophagidae, Delia platura, Delia antiqua, fruit flies, fruit vinegar flies, moth flies, tsetse flies, and Stomoxys calcitrans; horseflies, such as Tabanus stygius, Tabanus trigonus, Chrysops suavis, and Haematopota pluvialis; biting midges, such as Leptoconops nipponensis, Culicoides sumatrae, and Culicoides arakawae; and bees, such as Vespa simillima xanthoptera, Polistes jokahamae, and honeybees.

The flying pest exterminating composition of the present invention exhibits an excellent extermination effect particularly against mosquitoes among them.

In the present invention, the “wing wetting agent” refers to a wetting agent capable of wetting wings of a flying pest, and more specifically, it is a component which when brought into contact with wings of a flying pest to wet them, exhibits the aforementioned extermination effect of the flying pest by action to lower the flying ability of the flying pest.

In more detail, the wording “wetting wings of a flying pest” refers to a state that a contact angle against the wing of the flying pest is 115° or less. From this viewpoint, in the wing wetting agent in the present invention, the contact angle of a 3 mmol/kg aqueous solution against the wing of the flying pest is 115° or less, preferably 90° or less, and more preferably 80° or less. Then, when the aforementioned contact angle of the wing wetting agent against the wing of the flying pest is 90° or less, it can be judged that the action to wet the wings of the flying pest is excellent. In addition, from the viewpoint of enhancing the straightness of the sprayed droplets of the composition to efficiently exterminate the flying pests, the foregoing contact angle is preferably 30° or more, more preferably 40° or more, and still more preferably 50° or more.

The aforementioned contact angle is a value measured using a contact angle meter in the environment at 25° C. by the 0/2 method, and specifically, it can be measured by a method described in the section of Examples.

The composition of the present invention is used through spraying as droplets having an average particle diameter of 20 μm or more and 400 μm or less. The foregoing average particle diameter means a volume median particle diameter (D50) of the droplets of the composition sprayed (hereinafter also referred to simply as “sprayed droplets”) by using a spray container or the like. Specifically, the volume median particle diameter (D50) of the droplets is a value measured using a Spraytec laser diffraction system (Model No. STP5921, manufactured by Malvern Panalytical Instrument) by the laser diffraction method with respect to the sprayed droplets at a position of 15 cm in terms of a horizontal distance from an ejection port of a spray container in which the composition is filled and discharged, and specifically, it can be measured by a method described in the section of Examples. When the sprayed droplets of the composition in which the average particle diameter (D50) measured at a position of 15 cm in terms of a horizontal distance from an ejection port of a spray container measured by the aforementioned method is 20 μm or more and 400 μm or less is applied to the flying pests, the flying pests can be efficiently exterminated in actual use. The volume median particle diameter (D50) as referred to in the present invention means a particle diameter at which the cumulative volume frequency calculated from the smallest particle diameter side in terms of a volume fraction becomes 50%.

The composition according to the first embodiment of the present invention contains 0.01% by mass or more and 3.0% by mass or less of a wing wetting agent having a surface tension at 25° C. of 27.0 mN/m or more and 50.0 mN/m or less as a 3 mmol/kg aqueous solution and is used by being sprayed as the aforementioned droplets having an average particle diameter of 20 μm or more and 400 μm or less.

The composition according to the second embodiment of the present invention is a flying pest exterminating composition having a surface tension at 25° C. of 27.0 mN/m or more and 50.0 mN/m or less and contains 0.01% by mass or more and 3.0% by mass or less of a wing wetting agent, the composition being used by being sprayed as droplets having an average particle diameter of 20 μm or more and 400 μm or less.

The reasons why the effects of the present invention are obtained by these matters may be conjectured as follows.

When not only the aforementioned surface tension at 25° C. of the wing wetting agent which is used for the composition of the present invention or the composition of the present invention is 50.0 mN/m or less, but also the content of the wing wetting agent in the composition falls within the aforementioned range, the action to wet wings of a flying pest is excellent, and the effect for lowering the flying ability is improved. Furthermore, when the surface tension at 25° C. of the wing wetting agent or the composition of the present invention is 27.0 mN/m or more, and the aforementioned average particle diameter of the sprayed droplets of the composition is 20 μm or more and 400 μm or less, it may be considered that when spraying the composition on flying pests, the sprayed droplets are easy to go straight without scattering vertically and horizontally and can efficiently reach the flying pest, therefore the aforementioned extermination effect of the flying pests can be improved.

That is, the present invention is concerned with one in which when a flying pest exterminating composition containing a wing wetting agent is sprayed as droplets having the aforementioned predetermined average particle diameter on a flying pest, it exterminates the flying pests due to an action to wet wings of the flying pest, thereby lowering the flying ability. For example, when the flying pest exterminating composition is sprayed on a flying pest during flying, the flying pest drops owing to wetting of wings thereof and are alive but cannot fly, whereby it becomes a detoxified state against humans. Therefore, the flying pest exterminating composition of the present invention is, for example, distinguished from an insecticide containing an insecticidal component.

In the light of the above, the flying pest exterminating composition of the present invention is one using a wetting agent (wing wetting agent) capable of wetting wings of a flying pest as an active component for flying pest extermination and can be made as a flying pest exterminating composition having a high extermination effect even without containing an insecticidal component, and therefore, it has high safety for the human body and the environment.

The flying pest exterminating composition of the present invention may be applied to not only pests during flying but also, for example, flying pests landing on the wall or the ground.

Furthermore, as for the composition of the present invention, from the viewpoint of suppressing stickiness to be caused due to attachment of the sprayed composition onto the surface to be sprayed, it is preferred that the content of the wing wetting agent in the composition is 0.55% by mass or less, and the average particle diameter of the sprayed droplets of the composition is 200 μm or less. Although the use place is not particularly limited, for example, in the case of being used indoors, the stickiness to the floor, the wall, or the like can be suppressed, and the handleability can be made more favorable.

The details of the flying pest exterminating composition and the spray container of the present invention are hereunder described.

### <Flying Pest Exterminating Composition>

The flying pest exterminating composition according to the first embodiment of the present invention contains 0.01% by mass or more and 3.0% by mass or less of a wing wetting agent having a surface tension at 25° C. of 27.0 mN/m or more and 50.0 mN/m or less as a 3 mmol/kg aqueous solution.

The flying pest exterminating composition according to the second embodiment of the present invention is a flying pest exterminating composition containing 0.01% by mass or more and 3.0% by mass or less of a wing wetting agent, the composition being used by being sprayed in the form of droplets having an average particle diameter of 20 μm or more and 400 μm or less and having a surface tension at 25° C. of 27.0 mN/m or more and 50.0 mN/m or less.

From the viewpoint that the flying pest exterminating composition is used by spraying on flying pests, it is preferred that the composition further contains water as a medium of dissolving or dispersing the wing wetting agent that is an active ingredient for exterminating flying pests, as mentioned later.

### (Wing Wetting Agent)

The wing wetting agent as referred to in the present invention means a wetting agent capable of wetting wings of a flying pest.

As for the wing wetting agent which is used for the composition according to the first embodiment, its surface tension at 25° C. is 27.0 mN/m or more and 50.0 mN/m or less as a 3 mmol/kg aqueous solution. When the surface tension of the wing wetting agent falls within the aforementioned range, not only the action to wet wings of the flying pest is excellent, and the effect for lowering the flying ability is high, but also when spraying the composition, the sprayed droplets are easy to go straight without scattering vertically and horizontally and can efficiently reach the flying pest.

The surface tension at 25° C. of the wing wetting agent is prescribed as the surface tension of a 3 mmol/kg aqueous solution. This is because so far as the surface tension at this concentration is concerned, there is no influence by other organic solvent or the like, and the surface tension originated from the wing wetting agent itself can be measured.

From the viewpoint of enhancing the straightness of the sprayed droplets of the composition to efficiently exterminate the flying pests, the foregoing surface tension is preferably 27.5 mN/m or more, more preferably 28.0 mN/m or more, still more preferably 29.0 mN/m or more, and yet still more preferably 29.5 mN/m or more. In addition, from the viewpoint that the action to wet wings of the flying pest is excellent, and the flying ability is lowered to enhance the extermination effect, the foregoing surface tension is preferably 45.0 mN/m or less, more preferably 40.0 mN/m or less, still more preferably 33.0 mN/m or less, and yet still more preferably 31.0 mN/m or less. Then, the surface tension at 25° C. of the wing wetting agent which is used for the composition according to the first embodiment of the present invention as a 3 mmol/kg aqueous solution is 27.0 to 50.0 mN/m, preferably 27.0 to 45.0 mN/m, more preferably 27.0 to 40.0 mN/m, still more preferably 27.5 to 40.0 mN/m, yet still more preferably 28.0 to 33.0 mN/m, even yet still more preferably 29.0 to 31.0 mN/m, and especially preferably 29.5 to 31.0 mN/m.

As for the wing wetting agent which is used for the composition according to the second embodiment of the present invention, it is preferred that the surface tension at 25° C. as a 3 mmol/kg aqueous solution falls within the aforementioned range, too.

The aforementioned surface tension is a value of the surface tension of a 3 mmol/kg aqueous solution of the wing wetting agent, as measured in the environment at 25° C. by the Wilhelmy method, and specifically, it can be measured by a method described in the section of Examples. In addition, in the case where the wing wetting agent is composed of two or more components, the surface tension value of the foregoing wing wetting agent is determined as a weighted average value while making a blending ratio of each component as a weight on the basis of the surface tension value of a 3 mmol/kg aqueous solution of each component.

Even if the surface tension at 25° C. of a single wing wetting agent as a 3 mmol/kg aqueous solution is less than 27.0 mN/m or more than 50.0 mN/m, so long as the foregoing surface tension as the wing wetting agent composed of two or more components falls within the range of 27.0 mN/m or more and 50.0 mN/m or less, the flying pest extermination effect is exhibited.

Although the wing wetting agent in the present invention may have a surface tension falling within the aforementioned specified range, from the viewpoint that the flying pest exterminating composition is used by spraying on flying pests, the wing wetting agent is preferably a water-soluble or water-dispersible compound capable of being dissolved or dispersed in an aqueous medium, such as water.

Among the water-soluble or water-dispersible compounds, from the viewpoint that the flying pest exterminating composition is easily adjusted to a viscosity suitable for spraying and the viewpoint that the average particle diameter of the sprayed droplets of the composition is controlled to a specified range, a molecular weight of the wing wetting agent is preferably 1,500 or less, more preferably 1,000 or less, still more preferably 800 or less, and yet still more preferably 600 or less. Although a lower limit value of the molecular weight of the wing wetting agent is not particularly restricted, it is preferably 150 or more, and more preferably 200 or more from the viewpoint of controlling the average particle diameter of the sprayed droplets of the composition to the specified range and the viewpoint of suppressing volatilization of the wing wetting agent.

Examples of the compound which is used as the wing wetting agent in the present invention include compounds known as a general surfactant and having a surface tension falling within the aforementioned range.

Among the surfactants, from the viewpoint of safety for the human body and the environment, at least one selected from the group consisting of a nonionic surfactant, an anionic surfactant, and a cationic surfactant is preferably contained, at least one selected from the group consisting of a nonionic surfactant and an anionic surfactant is more preferably contained, and a nonionic surface is still more preferably contained, and the surfactant is yet still more preferably a nonionic surfactant.

### [Nonionic Surfactant]

The nonionic surfactant which is used as the wing wetting agent is preferably a nonionic surfactant having an HLB (hydrophile-lipophile balance) value of 18.0 or less from the viewpoint that the action to wet wings of the flying pest is excellent. The foregoing HLB value is more preferably 16.0 or less, and still more preferably 15.0 or less. In addition, from the viewpoint of enhancing the straightness of the sprayed droplets of the composition to efficiently exterminate the flying pests, the foregoing HLB value is preferably 7.0 or more, more preferably 8.5 or more, still more preferably 10.0 or more, and yet still more preferably 11.5 or more.

Here, the HLB value is a value exhibiting an affinity of the surfactant with water and an oil and can be determined by the Griffin method according to following equation. In the case where the nonionic surfactant is composed of two or more components, the HLB is one determined as a weighted average value while making a blending ratio of each component as a weight on the basis of the HLB value of each component. In the following equation, examples of the “hydrophilic groups contained in the surfactant” include a hydroxy group and an ethyleneoxy group.

HLB=20×[(Sum total of formula weights of hydroxy groups contained in the surfactant)/(Molecular weight of the surfactant)]

Specific examples of the nonionic surfactant include a polyoxyalkylene alkyl ether, a polyoxyalkylene sorbitan fatty acid ester, an alkyl glucoside, an alkyl glyceryl ether, a polyglycerin fatty acid ester, a polyoxyethylene hydrogenated castor oil, an alkylamine oxide, and a polyoxyethylene-modified silicone. These can be used alone or in combination of two or more thereof.

Of these, at least one selected from the group consisting of a polyoxyalkylene alkyl ether, an alkyl glucoside, and an alkyl glyceryl ether is preferred, and at least one selected from the group consisting of a polyoxyalkylene alkyl ether and an alkyl glucoside is more preferred from the viewpoint that the action to wet wings of the flying pest is excellent and the viewpoint that the straightness of the sprayed droplets of the composition is enhanced to efficiently exterminate the flying pests.

The polyoxyalkylene alkyl ether is preferably a compound represented by the following general formula (1).

R¹—O—(Y)ₘ—H (1)

In the formula (1), R¹ represents an alkyl group; Y represents an oxyethylene unit and/or an oxypropylene unit; and m represents an average addition molar number of Y.

In the general formula (1), the carbon atom number of the alkyl group constituting R¹ is preferably 8 or more and 22 or less, more preferably 8 or more and 18 or less, and still more preferably 8 or more and 14 or less from the viewpoint that the action to wet wings of the flying pest is excellent and the viewpoint that the straightness of the sprayed droplets of the composition is enhanced to efficiently exterminate the flying pests. Although the alkyl group may be any of a linear alkyl group and a branched alkyl group, it is preferably a linear alkyl group from the viewpoint that the surface tension is lowered, and the action to wet wings of the flying pest is excellent.

Y represents an oxyethylene unit and/or an oxypropylene unit, and Y is preferably an oxyethylene unit. m represents an average addition molar number of Y, and m is preferably 4 or more, and more preferably 6 or more from the viewpoint of enhancing the straightness of the sprayed droplets of the composition to efficiently exterminate the flying pests. In addition, from the viewpoint that the action to wet wings of the flying pest is excellent, the foregoing average addition molar number is preferably 30 or less, more preferably 20 or less, still more preferably 15 or less, yet still more preferably 12 or less, and even yet still more preferably 10 or less.

The polyoxyalkylene alkyl ether is more preferably a polyoxyethylene lauryl ether in which the average addition molar number of the oxyethylene group is 6 or more and 10 or less.

Examples of the alkyl glucoside include an alkyl glucoside having an alkyl group having preferably 8 or more and 22 or less carbon atoms, more preferably 8 or more and 18 or less carbon atoms, and still more preferably 8 or more and 14 or less carbon atoms. The alkyl group may be any of a linear alkyl group and a branched alkyl group.

Specific examples of the alkyl glucoside include octyl glucoside, 2-ethylhexyl glucoside, nonyl glucoside, decyl glucoside, isodecyl glucoside, lauryl glucoside, tridecyl glucoside, myristyl glucoside, stearyl glucoside, isostearyl glucoside, and a mixture of two or more thereof. Of these, at least one selected from the group consisting of decyl glucoside, lauryl glucoside, and myristyl glucoside is preferred.

Examples of the alkyl glyceryl ether include an alkyl glyceryl ether having an alkyl group having preferably 8 or more and 22 or less carbon atoms, more preferably 8 or more and 18 or less carbon atoms, and still more preferably 8 or more and 14 or less carbon atoms. Although the alkyl group may be any of a linear alkyl group and a branched alkyl group, it is preferably a branched alkyl group from the viewpoint of enhancing the straightness of the sprayed droplets of the composition to efficiently exterminate the flying pests.

Specific examples of the alkyl glyceryl ether include octyl glyceryl ether, 2-ethylhexyl glyceryl ether, nonyl glyceryl ether, decyl glyceryl ether, isodecyl glyceryl ether, lauryl glyceryl ether, tridecyl glyceryl ether, myristyl glyceryl ether, stearyl glyceryl ether, isostearyl glyceryl ether, and a mixture of two or more thereof. Of these, at least one selected from the group consisting of 2-ethylhexyl glyceryl ether, decyl glyceryl ether, isodecyl glyceryl ether, and lauryl glyceryl ether is preferred, and at least one selected from the group consisting of 2-ethylhexyl glyceryl ether and isodecyl glyceryl ether is more preferred.

### [Anionic Surfactant]

Examples of the anionic surfactant which is used as the wing wetting agent include an alkylbenzenesulfonic acid salt, an alkyl or alkenyl ether sulfuric acid salt, an alkyl or alkenyl sulfuric acid salt, an alkylsulfonic acid salt, a saturated or unsaturated fatty acid salt, an alkyl or alkenyl ether carboxylic acid salt, an α-sulfofatty acid salt, an N-acyl amino acid, a phosphoric acid mono- or diester, and a sulfosuccinic acid ester, each of which has a surface tension falling within the aforementioned range, and one or more thereof can be used.

Examples of a counter ion of the anionic group of the anionic surfactant include an alkali metal ion, such as a sodium ion and a potassium ion; an alkaline earth metal ion, such as a calcium ion and a magnesium ion; an ammonium ion; and an alkanolammonium having 1 to 3 alkanol groups having 2 or 3 carbon atoms (for example, monoethanolammonium, diethanolammonium, triethanolammonium, and triisopropanolammonium).

From the viewpoint that the action to wet wings of the flying pest is excellent and the viewpoint that the straightness of the sprayed droplets of the composition is enhanced to efficiently exterminate the flying pests, the anionic surfactant is preferably at least one selected from the group consisting of an alkyl sulfuric acid salt, an alkyl ether sulfuric acid salt, and an alkyl ether carboxylic acid salt, and more preferably an alkyl sulfuric acid salt. Examples of the alkyl sulfuric acid salt include sodium lauryl sulfate and ammonium lauryl sulfate. Examples of the alkyl ether sulfuric acid salt include a polyoxyethylene alkyl ether sulfuric acid salt, such as sodium laureth sulfate, and examples of the alkyl ether carboxylic acid salt include a polyoxyethylene alkyl ether acetic acid salt, such as sodium laureth acetate.

### [Cationic Surfactant]

Examples of the cationic surfactant which is used as the wing wetting agent include an alkyl trimethylammonium salt, an alkoxyalkyl trimethylammonium salt, a dialkyl dimethylammonium salt, an alkylamidoalkyl trimethylammonium salt, benzalkonium chloride, an alkyl pyridinium salt, an alkyl dimethylamine and a salt thereof, an alkoxyalkyl dimethylamine and a salt thereof, an alkylamidoalkyl dimethylamine and a salt thereof, a diethanolamine monoalkyl ester and a salt thereof, a triethanolamine monoalkyl ester and a salt thereof, and a triethanolamine dialkyl ester and a salt thereof, each of which has a surface tension falling within the aforementioned range.

The alkyl group in the alkyl trimethylammonium salt, the alkoxyalkyl trimethylammonium salt, the dialkyl dimethylammonium salt, the alkyl pyridinium salt, the alkyl dimethylamine and its salt, and the alkoxyalkyl dimethylamine and its salt has preferably 8 or more and 22 or less carbon atoms, and more preferably 8 or more and 18 or less carbon atoms from the viewpoint that the action to wet wings of the flying pest is excellent and the viewpoint that the straightness of the sprayed droplets of the composition is enhanced to efficiently exterminate the flying pests.

The alkyl group in the alkylamidoalkyl trimethylammonium salt, the alkylamidoalkyl dimethylamine and its salt, the diethanolamine monoalkyl ester and its salt, the triethanolamine monoalkyl ester and its salt, and the triethanolamine dialkyl ester and its salt has preferably 7 or more and 21 or less carbon atoms, and more preferably 7 or more and 17 or less carbon atoms from the viewpoint that the action to wet wings of the flying pest is excellent and the viewpoint that the straightness of the sprayed droplets of the composition is enhanced to efficiently exterminate the flying pests.

Examples of a counter ion of the cationic group in the alkyl trimethylammonium salt, the alkoxyalkyl trimethylammonium salt, the dialkyl dimethylammonium salt, the alkylamidoalkyl trimethylammonium salt, and the alkyl pyridinium salt include an alkyl sulfate ion having 1 or more and 3 or less carbon atoms, a sulfuric acid ion, a phosphoric acid ion, a carboxylic acid ion having 1 or more and 3 or less carbon atoms (e.g., a formic acid ion, an acetic acid ion, and a propionic acid ion), and a halide ion, such as a chloride ion and a bromide ion. Of these, from the viewpoint of easiness of production and easiness of availability of raw materials, a halide ion is preferred, and a chloride ion is more preferred.

Each of the alkyl dimethylamine, the alkoxyalkyl dimethylamine, the alkylamidoalkyl dimethylamine, the diethanolamine monoalkyl ester, the triethanolamine monoalkyl ester, and the triethanolamine dialkyl ester may be previously reacted with an acid and then blended as the salt in the composition; or it may be blended directly in the composition, with which is then blended an acid to form a salt in the composition. In consequence, the aforementioned amine, alkyl ester, and salt thereof are herein defined as the cationic surfactant. In addition, the content thereof is expressed in terms of a mass of the aforementioned amine and alkyl ester.

Examples of the salt of each of the alkyl dimethylamine, the alkoxyalkyl dimethylamine, the alkylamidoalkyl dimethylamine, the diethanolamine monoalkyl ester, the triethanolamine monoalkyl ester, and the triethanolamine dialkyl ester include salts of an organic acid or an inorganic acid. Examples of the organic acid include a monocarboxylic acid, such as acetic acid and propionic acid; a dicarboxylic acid, such as malonic acid, succinic acid, glutaric acid, adipic acid, maleic acid, fumaric acid, and phthalic acid; a polycarboxylic acid, such as polyglutamic acid; a hydroxycarboxylic acid, such as glycolic acid, lactic acid, hydroxyacrylic acid, glyceric acid, malic acid, tartaric acid, and citric acid; and an acidic amino acid, such as glutamic acid and aspartic acid. Examples of the inorganic acid include hydrochloric acid, sulfuric acid, and phosphoric acid.

From the viewpoint that the action to wet wings of the flying pest is excellent and the viewpoint that the straightness of the sprayed droplets of the composition is enhanced to efficiently exterminate the flying pests, the cationic surfactant is preferably benzalkonium chloride.

The wing wetting agent can be used alone or in combination of two or more thereof.

In the case where the wing wetting agent contains a nonionic surfactant, from the viewpoint that the action to wet wings of the flying pest is excellent, the content of the nonionic surfactant in the wing wetting agent is preferably 50% by mass or more, more preferably 70% by mass or more, still more preferably 80% by mass or more, yet still more preferably 90% by mass or more, and even yet still more preferably 95% by mass or more, and in addition, it is 100% by mass or less, and most preferably substantially 100% by mass.

As examples of other components than the nonionic surfactant in the wing wetting agent, at least one selected from the group consisting of the aforementioned anionic surfactant and cationic surfactant is preferred, and the anionic surfactant is more preferred.

From the viewpoint that the action to wet wings of the flying pest is excellent, the content of the wing wetting agent in the flying pest exterminating composition of the present invention is 0.01% by mass or more, preferably 0.02% by mass or more, more preferably 0.05% by mass or more, still more preferably 0.08% by mass or more, and yet still more preferably 0.10% by mass or more. In addition, from the viewpoint of enhancing the straightness of the sprayed droplets of the composition to efficiently exterminate the flying pests, the content of the wing wetting agent in the flying pest exterminating composition of the present invention is 3.0% by mass or less, preferably 2.0% by mass or less, more preferably 1.0% by mass or less, and still more preferably 0.80% by mass or less, and from the viewpoint that when using the flying pest exterminating composition, stickiness to be caused due to attachment of the sprayed composition onto the surface to be sprayed is suppressed, the foregoing content is yet still more preferably 0.55% by mass or less, and even yet still more preferably 0.40% by mass or less. Then, the content of the wing wetting agent in the flying pest exterminating composition of the present invention is 0.01 to 3.0% by mass, preferably 0.02 to 2.0% by mass, still more preferably 0.05 to 1.0% by mass, yet still more preferably 0.08 to 1.0% by mass, and even yet still more preferably 0.10 to 0.80% by mass. In addition, from the viewpoint that when using the flying pest exterminating composition, stickiness to be caused due to attachment of the sprayed composition onto the surface to be sprayed is suppressed, the content of the wing wetting agent in the flying pest exterminating composition is preferably 0.01 to 0.55% by mass, and more preferably 0.01 to 0.40% by mass, and from the viewpoint that the action to wet wings of the flying pest is excellent, it is still more preferably 0.10 to 0.40% by mass.

It is preferred that the flying pest exterminating composition of the present invention further contains an aqueous medium as a medium of dissolving or dispersing the wing wetting agent that is an active ingredient for exterminating flying pests. As the aqueous medium, water is preferred from the viewpoint of safety for the human body and the environment and the viewpoint of adjusting the sprayed droplets to the predetermined range.

The content of water in the composition is preferably 80% by mass or more, more preferably 90% by mass or more, still more preferably 97% by mass or more, and yet still more preferably 99% by mass or more, and preferably 99.99% by mass or less, and more preferably 99.9% by mass or less.

A content ratio ((wing wetting agent)/water) of the wing wetting agent to the content of water in the composition is preferably 0.02 or less, and more preferably 0.01 or less in terms of a mass ratio from the viewpoint of suppressing stickiness to be caused due to attachment of the sprayed composition onto the surface to be sprayed.

### <Other Components>

The flying pest exterminating composition can contain other components than those as mentioned above, for example, a preservative, a coloring agent, a fragrance, and a pH modifier, within a range where the effects of the present invention are not impaired. In addition, an aqueous medium other than water, for example, an alcohol having 1 to 5 carbon atoms, such as methanol, ethanol, isopropyl alcohol, and butyl alcohol; and a diol or triol having 6 or less carbon atoms, such as 1,3-butylene glycol, glycerin, ethylene glycol, and propylene glycol, may be contained.

However, from the viewpoint of obtaining the effects of the present invention, the content of the other components than the wing wetting agent and water in the flying pest exterminating composition is preferably 20% by mass or less, more preferably 15% by mass or less, still more preferably 10% by mass or less, yet still more preferably 5% by mass or less, even yet still more preferably 1% by mass or less, even still more preferably 0.5% by mass or less, and even still more further preferably 0.1% by mass or less. In particular, the content of ethanol in the flying pest exterminating composition is preferably 0.2% by mass or less, and more preferably 0.1% by mass or less.

From the viewpoint of safety for the human body and the environment, it is preferred that the flying pest exterminating composition does not contain an insecticidal component. This is because the flying pest exterminating composition in the present invention is one in which the wing wetting agent capable of wetting wings of the flying pest is used as an active ingredient for exterminating flying pests, and even if no insecticidal component is contained, the composition having a high flying pest extermination effect can be provided.

Examples of the insecticidal component as referred to herein include a pyrethroid-based insecticide, an organophosphorus-based insecticidal component, and a carbamate-based insecticidal component.

Examples of the pyrethroid-based insecticide include metofluthrin, dl,d-T80-allethrin, phthalthrin, d-T80-phthalthrin, d,d-T80-prallethrin, d,d-T98-prallethrin, d-T80-resmethrin, transfluthrin, imiprothrin, cyphenothrin, d,d-T-cyphenothrin, empenthrin, permethrin, phenothrin, etofenprox, and pyrethrin.

Examples of other insecticidal component than the pyrethroid-based insecticide include an organophosphorus-based insecticide, such as fenitrothion and malathion; a carbamate-based insecticide, such as propoxur and carbaryl; a miticide, such as kelthane, quinomethionate, and hexathiazox; and a neonicotinoid-based insecticide, such as imidacloprid, dinotefuran, and clothianidin.

The wording “no insecticidal component is contained” means that the content of the insecticidal component in the flying pest exterminating composition is less than 1% by mass, preferably 0.1% by mass or less, more preferably 0.01% by mass or less, and still more preferably 0.001% by mass or less, and especially preferably, the insecticidal component is not substantially contained.

From the viewpoint of safety for the human body and the environment, it is preferred that the flying pest exterminating composition of the present invention does not contain a disinfectant. Examples of the disinfectant as referred to herein include an amphoteric surfactant having a disinfecting effect. The wording “not contain a disinfectant” means that the content of the disinfectant in the flying pest exterminating composition is less than 0.1% by mass, preferably 0.05% by mass or less, more preferably 0.01% by mass or less, and still more preferably 0.005% by mass or less, and especially preferably, the disinfectant is not substantially contained.

As for the flying pest exterminating composition of the present invention, it is preferred that the content of a polymer compound is smaller from the viewpoint of facilitating adjustment of the flying pest exterminating composition to a viscosity suited for spraying, the viewpoint of controlling the average particle diameter of the sprayed droplets of the composition to a specified range, and the viewpoint of suppressing stickiness to be caused due to attachment of the sprayed composition onto the surface to be sprayed during using the flying pest exterminating composition. For example, the content of a (meth)acrylic acid alkyl ester copolymer in the flying pest exterminating composition is preferably less than 0.5% by mass, more preferably less than 0.1% by mass, still more preferably 0.07% by mass or less, and yet still more preferably 0.05% by mass or less.

The aforementioned (meth)acrylic acid alkyl ester copolymer means a polymer compound resulting from copolymerization of a (meth)acrylic acid alkyl ester, and in particular, a film-formable (meth)acrylic acid alkyl ester copolymer is corresponding thereto.

The film-formable (meth)acrylic acid alkyl ester copolymer may be any of cationic, anionic, nonionic, and amphoteric compounds. Among the film-formable (meth)acrylic acid alkyl ester copolymers, examples of the amphoteric polymer compound include an N-methacryloyloxyethyl N,N-dimethylammonium-α-N-methylcarboxybetaine/methacrylic acid alkyl ester copolymer (e.g., “YUKA FORMER 202”, “YUKA FORMER 104D”, “YUKA FORMER AMPHOSET”, “YUKA FORMER R205S”, and “YUKA FORMER SM”, all of which are manufactured by Mitsubishi Chemical Corporation), an octylamide acrylate/hydroxypropyl acrylate/butylaminoethyl methacrylate copolymer, and an N-methacryloyloxyethyl N,N-dimethylaminoethyl-α-N-methyl carboxybetaine/alkyl ester methacrylate copolymer.

When the content of the film-formable (meth)acrylic acid alkyl ester copolymer in the composition of the present invention is small, the viscosity rise of the composition is suppressed. For that reason, in the case of using a trigger spray type container as the spray container, a speed of pulling a trigger is not lowered and is stabilized. When the speed of pulling a trigger is fast, since the pressure applied to the droplets becomes high, the sprayed droplets of the composition readily become small. In addition, in view of the fact that the speed of pulling a trigger becomes stable, when the liquid film of the composition comes loose into droplets due to a power of spinning, the sprayed droplets readily become small, and the particle diameter control becomes easy.

In the case where the composition of the present invention contains the (meth)acrylic acid alkyl ester copolymer, the content of the wing wetting agent in the flying pest exterminating composition is preferably 1.0% by mass or less, and more preferably 0.8% by mass or less from the viewpoint that when using the flying pest exterminating composition, stickiness to be caused due to attachment of the sprayed composition onto the surface to be sprayed is suppressed.

In the case where the flying pest exterminating composition of the present invention is filled in an aerosol type container having a propellant filled therein as mentioned later and then used, the content of each of the components in the composition of the present invention means % by mass in the whole quantity from which the propellant is excluded.

In the composition according to the second embodiment of the present invention, the surface tension at 25° C. is 27.0 mN/m or more and 50.0 mN/m or less from the viewpoint of enhancing the straightness of the sprayed droplets of the composition to efficiently exterminate the flying pests. In view of the fact that the surface tension at 25° C. of the composition according to the second embodiment falls within the aforementioned range, not only the action to wet wings of the flying pest is excellent, and the lowering effect of the flying ability becomes high, but also when spraying the composition, the sprayed droplets readily go straight without scattering vertically and horizontally and can be made to efficiently reach the flying pest.

From the viewpoint of enhancing the straightness of the sprayed droplets of the composition to efficiently reach the flying pests, the foregoing surface tension is preferably 27.5 mN/m or more, more preferably 28.0 mN/m or more, still more preferably 29.0 mN/m or more, and yet still more preferably 29.5 mN/m or more. In addition, from the viewpoint that the action to wet wings of the flying pest is excellent, and the flying ability is lowered to enhance the extermination effect, the foregoing surface tension is preferably 45.0 mN/m or less, more preferably 40.0 mN/m or less, still more preferably 33.0 mN/m or less, and yet still more preferably 31.0 mN/m or less. Then, the surface tension at 25° C. of the composition according to the second embodiment of the present invention is 27.0 to 50.0 mN/m, preferably 27.0 to 45.0 mN/m, more preferably 27.0 to 40.0 mN/m, still more preferably 27.5 to 40.0 mN/m, yet still more preferably 28.0 to 33.0 mN/m, even yet still more preferably 29.0 to 31.0 mN/m, and especially preferably 29.5 to 31.0 mN/m.

It is preferred that the surface tension at 25° C. of the composition according to the first embodiment of the present invention falls within the aforementioned range, too.

The surface tension of the composition can be measured by the same method as mentioned above and is measured in the environment at 25° C. by the Wilhelmy method. Specifically, the surface tension can be measured by a method described in the second of Examples.

A kinematic viscosity at 25° C. of the flying pest exterminating composition of the present invention is preferably 0.8 mm²/s or more, and more preferably 0.9 mm²/s or more from the viewpoint of enhancing the straightness of the sprayed droplets of the composition to efficiently exterminate the flying pests, and it is preferably 2.5 mm²/s or less, more preferably 2.0 mm²/s or less, and still more preferably 1.5 mm²/s or less from the viewpoint of enhancing flying of the sprayed droplets of the composition to efficiently exterminate the flying pests. The kinematic viscosity can be measured by an Ubbelohde viscometer, and specifically, it can be measured by a method described in the section of Examples.

The production method of the flying pest exterminating composition of the present invention is not particularly limited. For example, the flying pest exterminating composition can be produced by blending the wing wetting agent, water, and other components which are used as the need arises and mixing the blend using a known stirring device or the like.

### <Sprayed Droplets>

The flying pest exterminating composition of the present invention is used through spraying as droplets having an average particle diameter of 20 μm or more and 400 μm or less. It may be considered that when the composition is sprayed as droplets having this average particle diameter on a flying pest, the sprayed droplets readily go straight without scattering vertically and horizontally and can be made to efficiently reach the flying pest, so that the extermination effect of the flying pest can be improved.

As mentioned above, the average particle diameter of the sprayed droplets of the flying pest exterminating composition means a volume median particle diameter (D50) of the droplets of the composition sprayed by using a spray container or the like, and it is a value measured using a Spraytec laser diffraction system (Model No. STP5921, manufactured by Malvern Panalytical Instrument) by the laser diffraction method with respect to the sprayed droplets at a position of 15 cm in terms of a horizontal distance from an ejection port of a spray container in which the composition is filled and discharged. Specifically, it can be measured by a method described in the section of Examples.

The average particle diameter of the sprayed droplets is 20 μm or more, preferably 30 μm or more, more preferably 50 μm or more, and still more preferably 70 μm or more from the viewpoint of enhancing the straightness of the sprayed droplets of the composition to efficiently exterminate the flying pests, and it is 400 μm or less, and preferably 300 μm or less from the viewpoint of enhancing scatterability of the sprayed droplets of the composition to efficiently exterminate the flying pests. Furthermore, from the viewpoint that when using the flying pest exterminating composition of the present invention, stickiness to be caused due to attachment of the sprayed composition onto the surface to be sprayed is suppressed, the average particle diameter of the sprayed droplets is more preferably 200 μm or less, and still more preferably 170 μm or less.

It is more preferred that a volume particle diameter distribution of the sprayed droplets of the flying pest exterminating composition satisfies the following requirements.

From the viewpoint of enhancing the straightness of the sprayed droplets of the composition to efficiently exterminate the flying pests, in the distribution curve of droplet particles of the sprayed droplets measured using a Spraytec laser diffraction system (Model No. STP5921, manufactured by Malvern Panalytical Instrument) by the laser diffraction method, a proportion of the sprayed droplets having a particle diameter of 10 μm or less relative to the volume of the whole of droplet particles is preferably 15% or less, more preferably 10% or less, and still more preferably 5% or less.

From the viewpoint of enhancing the straightness of the sprayed droplets of the composition to efficiently exterminate the flying pests, a proportion of the sprayed droplets having a particle diameter of 30 μm or less relative to the volume of the whole of droplet particles is preferably 15% or less, more preferably 10% or less, and still more preferably 5% or less.

On the other hand, from the viewpoint that when using the flying pest exterminating composition, stickiness to be caused due to attachment of the sprayed composition onto the surface to be sprayed is suppressed, a proportion of the sprayed droplets having a particle diameter of 500 μm or more relative to the volume of the whole of droplet particles is preferably 10% or less, more preferably 5% or less, and still more preferably 1% or less.

From the viewpoint that when using the flying pest exterminating composition, stickiness to be caused due to attachment of the sprayed composition onto the surface to be sprayed is suppressed, a proportion of the sprayed droplets having a particle diameter of 300 μm or more relative to the volume of the whole of droplet particles is preferably 35% or less, more preferably 30% or less, and still more preferably 25% or less.

The volume particle diameter distribution of the sprayed droplets of the flying pest exterminating composition can be measured by the laser diffraction method in the same method as in the average particle diameter of the sprayed droplets, and specifically, it can be measured by a method described in the section of Examples.

The volume median particle diameter (D50) and the volume particle diameter distribution of the sprayed droplets of the flying pest exterminating composition of the present invention can be controlled by the surface tension and the content of the wing wetting agent which is used for the foregoing composition, the ejection orifice diameter of the spray container used, the discharge amount, and a combination thereof.

Examples of the method of spraying the foregoing composition as droplets having an average particle diameter of 20 μm or more and 400 μm or less include a method of filling the foregoing composition in a spray container as mentioned later and spraying it.

### [Flying Pest Exterminating Spray]

The present invention also provides a flying pest exterminating spray according to a first embodiment, including a flying pest exterminating composition filled in a spray container, wherein the composition contains 0.01% by mass or more and 3.0% by mass or less of a wing wetting agent having a surface tension at 25° C. of 27.0 mN/m or more and 50.0 mN/m or less as a 3 mmol/kg aqueous solution, the composition being used by being sprayed in the form of droplets having an average particle diameter of 20 μm or more and 400 μm or less.

The present invention also provides a flying pest exterminating spray according to a second embodiment, including a flying pest exterminating composition filled in a spray container, wherein the composition has a surface tension at 25° C. of 27.0 mN/m or more and 50.0 mN/m or less and contains 0.01% by mass or more and 3.0% by mass or less of a wing wetting agent, the composition being used by being sprayed in the form of droplets having an average particle diameter of 20 μm or more and 400 μm or less.

The aforementioned flying pest exterminating sprays according to the first and second embodiments are also hereinafter named generically as “flying pest exterminating spray of the present invention” unless otherwise specifically noted.

The spray in the present invention is configured of a flying pest exterminating composition and a spray container.

The flying pest exterminating compositions used for the flying pest exterminating sprays according to the first and second embodiments and suitable embodiments thereof are the same as those in the aforementioned flying pest exterminating compositions according to the first and second embodiments, respectively.

By providing the flying pest exterminating spray having the aforementioned configuration, wings of a flying pest are wetted to exhibit an action to lower the flying ability, whereby the flying pest can be efficiently exterminated.

### <Spray Container>

The spray container which is used for the flying pest exterminating spray of the present invention is not particularly restricted so long as it is able to fill the aforementioned flying pest exterminating composition and spray it in a state of spray droplets having an average particle diameter falling within a specified range on flying pests. Examples of such a spray container include an extrusion spray container, such as a trigger spray type container; and an aerosol type container having a propellant filled therein.

Although a capacity of the spray container is not particularly restricted, it is typically 50 mL or more and 500 mL or less from the viewpoint of spraying towards flying pests.

An ejection orifice diameter of the spray container is preferably 0.1 mm or more, and more preferably 0.3 mm or more from the viewpoint of readily controlling the average particle diameter of the sprayed droplets of the composition to a specified range, and it is preferably 1.5 mm or less, and more preferably 1.0 mm or less from the same viewpoint. The “ejection orifice diameter of the spray container” means a maximum diameter in the inner diameter of the ejection nozzle tip of the spray container. Although the shape of the discharge port is not particularly limited, it is preferably circular or oval.

From the viewpoint of readily controlling the average particle diameter of the sprayed droplets of the composition to a specified range, the spray container is preferably an extrusion spray container, more preferably a trigger spray type container, and still more preferably a trigger spray type container having an ejection orifice diameter falling within the aforementioned range.

Among the trigger spray type containers, an accumulation type trigger spray container is yet still more preferred from the viewpoint of readily controlling the average particle diameter of the sprayed droplets of the composition to a specified range. In general, the accumulation type spray container has a structure in which a piston is slid relative to a cylinder accommodated inside the container, to eject a liquid exceeding a fixed pressure within the cylinder from a nozzle. That is, since the liquid is first ejected outside the container in the case where the liquid pressure within the cylinder exceeds the fixed pressure, the accumulation type trigger spray container is advantageous from the standpoint of particle diameter control of the droplets ejected.

Examples of the accumulation type trigger spray container include a container described in JP 2017-226474 A.

Although the trigger spray type container may be provided with a foam forming mechanism, it is preferably one having no foam forming mechanism from the viewpoint of readily controlling the average particle diameter of the sprayed droplets of the composition to a specified range.

Specifically, the “foam forming mechanism” means the following mechanism (1) or (2).
(1) A mechanism having a projection-provided plate-shaped body or a mesh-like barrier, as arranged in an ejection port of the container vertically to the ejection direction, in which the liquid ejected in the form of mist is allowed to collide against the plate-shaped body or the barrier, thereby mixing with air to form foams.
(2) A mechanism having an outside air introduction hole in the vicinity of an ejection port of a container, in which the liquid ejected in the form of mist is mixed with the introduced outside air within the container and collides against a cylindrical inner wall surface to form foams, which are then ejected forward from the ejection port.

Specific examples of the above (1) include mechanisms described in FIG. 15 of JP 2003-112090 A, JP 2011-251218 A, and FIG. 2 of JP 2006-320845 A.

Specific examples of the above (2) include mechanisms described in FIG. 2 of JP 2007-167719 A, FIG. 2 of JP 2006-150279 A, and FIG. 2 of JP 52-116919 A.

The trigger spray type container having no foam forming mechanism refers to a trigger spray type container of a structure in which the liquid is ejected as liquid droplets from the ejection port of the nozzle to the outside of the container without going through the aforementioned foam forming mechanism, and preferably, it refers to a trigger spray type container of a structure in which the droplets are ejected directly into the outside of the container from the ejection port of the nozzle.

The appearance shape of the sprayed droplets discharged from the trigger spray type container having no foam forming mechanism is preferably one in which after 1 minute of spraying one time with a full stroke toward a wall located at a horizontal distance of 30 cm from the ejection port of the container at room temperature (25° C.), no bubbles having a size of 100 μm or more are observed. The appearance shape of the sprayed droplets is more preferably one in which after 0.5 minutes of spraying one time with a full stroke toward a wall located at a horizontal distance of 30 cm from the ejection port of the container, no bubbles having a size of 100 μm or more are observed.

The discharge amount of the flying pest exterminating composition by the trigger spray type container is preferably 0.2 g/time or more, more preferably 0.5 g/time or more, and still more preferably 0.7 g/time or more in terms of a discharge amount per one time of trigger operation from the viewpoint of making a sufficient amount of sprayed droplets of the composition reach a flying pest to efficiently exterminate the flying pest. In addition, the foregoing discharge amount is preferably 2.0 g/time or less, more preferably 1.5 g/time or less, and still more preferably 1.2 g/time or less from the viewpoint that when using the flying pest exterminating spray, stickiness to be caused due to attachment of the sprayed composition onto the surface to be sprayed is suppressed.

On the other hand, the discharge amount of the flying pest exterminating composition by the aerosol type container is preferably 0.2 g or more, more preferably 0.5 g or more, and still more preferably 0.7 g or more in terms of a discharge amount during spraying for one second from the viewpoint of making a sufficient amount of sprayed droplets of the composition reach a flying pest to efficiently exterminate the flying pest. In addition, the foregoing discharge amount is preferably 2.0 g or less, more preferably 1.5 g or less, and still more preferably 1.2 g or less from the viewpoint that when using the flying pest exterminating spray, stickiness to be caused due to attachment of the sprayed composition onto the surface to be sprayed is suppressed.

The present invention further provides a flying pest controlling spray including a flying pest controlling composition filled in a spray container, wherein the composition contains 0.01% by mass or more and 3.0% by mass or less of a wing wetting agent having a surface tension at 25° C. of 27.0 mN/m or more and 50.0 mN/m or less as a 3 mmol/kg aqueous solution, the composition being used by being sprayed in the form of droplets having an average particle diameter of 20 μm or more and 400 μm or less; and a flying pest dropping spray including a flying pest dropping composition filled in a spray container, wherein the composition contains 0.01% by mass or more and 3.0% by mass or less of a wing wetting agent having a surface tension at 25° C. of 27.0 mN/m or more and 50.0 mN/m or less as a 3 mmol/kg aqueous solution, the composition being used by being sprayed in the form of droplets having an average particle diameter of 20 μm or more and 400 μm or less. The compositions and the spray containers used for these sprays and suitable embodiments thereof are the same as those in the aforementioned flying pest exterminating spray according to the first embodiment.

The present invention further provides a flying pest controlling spray including a flying pest controlling composition filled in a spray container, wherein the composition has a surface tension at 25° C. of 27.0 mN/m or more and 50.0 mN/m or less and contains 0.01% by mass or more and 3.0% by mass or less of a wing wetting agent, the composition being used by being sprayed in the form of droplets having an average particle diameter of 20 μm or more and 400 μm or less; and a flying pest dropping spray including a flying pest dropping composition filled in a spray container, wherein the composition has a surface tension at 25° C. of 27.0 mN/m or more and 50.0 mN/m or less and contains 0.01% by mass or more and 3.0% by mass or less of a wing wetting agent, the composition being used by being sprayed in the form of droplets having an average particle diameter of 20 μm or more and 400 μm or less. The compositions and the spray containers used for these sprays and suitable embodiments thereof are the same as those in the flying pest exterminating spray according to the second embodiment.

Regarding the aforementioned embodiments, the present invention further discloses the following embodiments.

<1>

A flying pest exterminating composition containing 0.01% by mass or more and 3.0% by mass or less of a wing wetting agent having a surface tension at 25° C. of 27.0 mN/m or more and 50.0 mN/m or less as a 3 mmol/kg aqueous solution and further containing 80% by mass or more and 99.99% by mass or less of water, the composition being used by being sprayed in the form of droplets having an average particle diameter of 20 μm or more and 400 μm or less.

<2>

A flying pest exterminating composition containing 0.01% by mass or more and 3.0% by mass or less of a wing wetting agent, the composition being used by being sprayed in the form of droplets having an average particle diameter of 20 μm or more and 400 μm or less and having a surface tension at 25° C. of 27.0 mN/m or more and 50.0 mN/m or less.

<3>

The composition as set forth in <2>, wherein a surface tension at 25° C. of a 3 mmol/kg aqueous solution of the wing wetting agent is preferably 27.0 mN/m or more and 50.0 mN/m or less.

<4>

The composition as set forth in any one of <1> to <3>, wherein the surface tension at 25° C. of a 3 mmol/kg aqueous solution of the wing wetting agent is preferably 27.5 mN/m or more, more preferably 28.0 mN/m or more, still more preferably 29.0 mN/m or more, and yet still more preferably 29.5 mN/m or more, and preferably 45.0 mN/m or less, more preferably 40.0 mN/m or less, still more preferably 33.0 mN/m or less, and yet still more preferably 31.0 mN/m or less.

<5>

The composition as set forth in any one of <1> to <4>, wherein the content of the wing wetting agent is preferably 0.02% by mass or more, more preferably 0.05% by mass or more, still more preferably 0.08% by mass or more, and yet still more preferably 0.10% by mass or more, and preferably 2.0% by mass or less, more preferably 1.0% by mass or less, still more preferably 0.80% by mass or less, yet still more preferably 0.55% by mass or less, and even yet still more preferably 0.40% by mass or less.

<6>

The composition as set forth in any one of <1> to <5>, wherein the average particle diameter of the droplets is preferably 30 μm or more, and more preferably 50 μm or more, and preferably 300 μm or less, more preferably 200 μm or less, and still more preferably 170 μm or less.

<7>

The composition as set forth in any one of <1> to <6>, wherein the wing wetting agent preferably contains at least one selected from the group consisting of a nonionic surfactant, an anionic surfactant, and a cationic surfactant, more preferably contains at least one selected from the group consisting of a nonionic surfactant and an anionic surfactant, and still more preferably contains a nonionic surfactant, and it is yet still more preferably a nonionic surfactant.

<8>

The composition as set forth in <7>, wherein an HLB value of the nonionic surfactant is preferably 18.0 or less, more preferably 16.0 or less, and still more preferably 15.0 or less, and preferably 7.0 or more, more preferably 8.5 or more, still more preferably 10.0 or more, and yet still more preferably 11.5 or more.

<9>

The composition as set forth in <7> or <8>, wherein the nonionic surfactant is at least one selected from the group consisting of a polyoxyalkylene alkyl ether, an alkyl glucoside, and an alkyl glyceryl ether.

<10>

The composition as set forth in <9>, wherein the polyoxyalkylene alkyl ether is a compound represented by the following general formula (1):

R¹—O—(Y)ₘ—H (1)

wherein R¹ represents an alkyl group, preferably a linear alkyl group or a branched alkyl group having preferably 8 or more and 22 or less carbon atoms, more preferably 8 or more and 18 or less carbon atoms, and still more preferably 8 or more and 14 or less carbon atoms, and more preferably a linear alkyl group having preferably 8 or more and 22 or less carbon atoms, more preferably 8 or more and 18 or less carbon atoms, and still more preferably 8 or more and 14 or less carbon atoms; Y represents an oxyethylene unit and/or an oxypropylene unit, and preferably an oxyethylene unit; and m represents an average addition molar number of Y, preferably 4 or more, and more preferably 6 or more, and preferably 30 or less, more preferably 20 or less, still more preferably 15 or less, yet still more preferably 12 or less, and even yet still more preferably 10 or less.
<11>

The composition as set forth in <10>, wherein the polyoxyalkylene alkyl ether is a polyoxyethylene lauryl ether in which the average addition molar number of the oxyethylene group is 6 or more and 10 or less.

<12>

The composition as set forth in <9>, wherein the alkyl glucoside is at least one selected from the group consisting of octyl glucoside, 2-ethylhexyl glucoside, nonyl glucoside, decyl glucoside, isodecyl glucoside, lauryl glucoside, tridecyl glucoside, myristyl glucoside, stearyl glucoside, isostearyl glucoside, and a mixture of two or more thereof, and preferably at least one selected from the group consisting of decyl glucoside, lauryl glucoside, and myristyl glucoside.

<13>

The composition as set forth in <9>, wherein the alkyl glyceryl ether is an alkyl glyceryl ether having an alkyl group (preferably a branched alkyl group) having preferably 8 or more and 22 or less carbon atoms, more preferably 8 or more and 18 or less carbon atoms, and still more preferably 8 or more and 14 or less carbon atoms.

<14>

The composition as set forth in <13>, wherein the alkyl glyceryl ether is preferably at least one selected from the group consisting of octyl glyceryl ether, 2-ethylhexyl glyceryl ether, nonyl glyceryl ether, decyl glyceryl ether, isodecyl glyceryl ether, lauryl glyceryl ether, tridecyl glyceryl ether, myristyl glyceryl ether, stearyl glyceryl ether, isostearyl glyceryl ether, and a mixture of two or more thereof, more preferably at least one selected from the group consisting of 2-ethylhexyl glyceryl ether, decyl glyceryl ether, isodecyl glyceryl ether, and lauryl glyceryl ether, and still more preferably at least one selected from the group consisting of 2-ethylhexyl glyceryl ether and isodecyl glyceryl ether.

<15>

The composition as set forth in <7>, wherein the anionic surfactant is at least one selected from the group consisting of an alkylbenzenesulfonic acid salt, an alkyl or alkenyl ether sulfuric acid salt, an alkyl or alkenyl sulfuric acid salt, an alkylsulfonic acid salt, a saturated or unsaturated fatty acid salt, an alkyl or alkenyl ether carboxylic acid salt, an α-sulfofatty acid salt, an N-acyl amino acid, a phosphoric acid mono- or diester, and a sulfosuccinic acid ester, preferably at least one selected from the group consisting of an alkyl sulfuric acid salt, an alkyl ether sulfuric acid salt, and an alkyl ether carboxylic acid salt, and more preferably an alkyl sulfuric acid salt.

<16>

The composition as set forth in <7>, wherein the cationic surfactant is at least one selected from the group consisting of an alkyl trimethylammonium salt, an alkoxyalkyl trimethylammonium salt, a dialkyl dimethylammonium salt, an alkylamidoalkyl trimethylammonium salt, benzalkonium chloride, an alkyl pyridinium salt, an alkyl dimethylamine and a salt thereof, an alkoxyalkyl dimethylamine and a salt thereof, an alkylamidoalkyl dimethylamine and a salt thereof, a diethanolamine monoalkyl ester and a salt thereof, a triethanolamine monoalkyl ester and a salt thereof, and a triethanolamine dialkyl ester and a salt thereof, and preferably benzalkonium chloride.

<17>

The composition as set forth in any one of <7> to <16>, wherein the content of the nonionic surfactant in the wing wetting agent is preferably 50% by mass or more, more preferably 70% by mass or more, still more preferably 80% by mass or more, yet still more preferably 90% by mass or more, and even yet still more preferably 95% by mass or more, and it is 100% by mass or less.

<18>

The composition as set forth in any one of <1> to <17>, wherein the content of water in the composition is preferably 90% by mass or more, more preferably 97% by mass or more, and still more preferably 99% by mass or more, and preferably 99.9% by mass or less.

<19>

The composition as set forth in any one of <1> to <18>, wherein the content of other components than the wing wetting agent and water in the composition is preferably 20% by mass or less, more preferably 15% by mass or less, still more preferably 10% by mass or less, yet still more preferably 5% by mass or less, even yet still more preferably 1% by mass or less, and even still more preferably 0.1% by mass or less.

<20>

The composition as set forth in any one of <1> to <19>, wherein a content ratio ((wing wetting agent)/water) of the wing wetting agent to the content of water in the composition is preferably 0.02 or less, and more preferably 0.01 or less in terms of mass ratio.

<21>

The composition as set forth in any one of <1> to <20>, wherein the content of ethanol in the composition is preferably 0.2% by mass or less, and more preferably 0.1% by mass or less.

<22>

The composition as set forth in any one of <1> to <21>, wherein the content of an insecticidal component in the composition is less than 1% by mass, preferably 0.1% by mass or less, more preferably 0.01% by mass or less, and still more preferably 0.001% by mass or less, and most preferably, the insecticidal component is not substantially contained.

<23>

The composition as set forth in any one of <1> to <22>, wherein the content of a disinfectant in the composition is less than 0.1% by mass, preferably 0.05% by mass or less, more preferably 0.01% by mass or less, and still more preferably 0.005% by mass or less, and most preferably, the disinfectant is not substantially contained.

<24>

The composition as set forth in any one of <1> to <23>, wherein the surface tension at 25° C. of the composition is 27.0 mN/m or more, preferably 27.5 mN/m or more, more preferably 28.0 mN/m or more, still more preferably 29.0 mN/m or more, and yet still more preferably 29.5 mN/m or more, and it is 50.0 mN/m or less, preferably 45.0 mN/m or less, more preferably 40.0 mN/m or less, still more preferably 33.0 mN/m or less, and yet still more preferably 31.0 mN/m or less.

<25>

The composition as set forth in any one of <1> to <24>, wherein the content of a (meth)acrylic acid alkyl ester copolymer in the composition is preferably less than 0.1% by mass, and more preferably 0.05% by mass or less.

<26>

The composition as set forth in any one of <1> to <25>, wherein a kinematic viscosity at 25° C. of the composition is preferably 0.8 mm²/s or more, and more preferably 0.9 mm²/s or more, and preferably 2.5 mm²/s or less, more preferably 2.0 mm²/s or less, and still more preferably 1.5 mm²/s or less.

<27>

A flying pest exterminating spray including a flying pest exterminating composition filled in a spray container, wherein
the composition contains 0.01% by mass or more and 3.0% by mass or less of a wing wetting agent having a surface tension at 25° C. of 27.0 mN/m or more and 50.0 mN/m or less as a 3 mmol/kg aqueous solution and further contains 80% by mass or more and 99.99% by mass or less of water, the composition being used by being sprayed in the form of droplets having an average particle diameter of 20 μm or more and 400 μm or less.
   <28>

A flying pest exterminating spray including a flying pest exterminating composition filled in a spray container, wherein
the composition has a surface tension at 25° C. of 27.0 mN/m or more and 50.0 mN/m or less, contains 0.01% by mass or more and 3.0% by mass or less of a wing wetting agent, and further contains 80% by mass or more and 99.99% by mass or less of water, the composition being used by being sprayed in the form of droplets having an average particle diameter of 20 μm or more and 400 μm or less.
   <29>

A flying pest controlling spray including a flying pest controlling composition filled in a spray container, wherein
the composition contains 0.01% by mass or more and 3.0% by mass or less of a wing wetting agent having a surface tension at 25° C. of 27.0 mN/m or more and 50.0 mN/m or less as a 3 mmol/kg aqueous solution and further contains 80% by mass or more and 99.99% by mass or less of water, the composition being used by being sprayed in the form of droplets having an average particle diameter of 20 μm or more and 400 μm or less.
   <30>

A flying pest dropping spray including a flying pest dropping composition filled in a spray container, wherein
the composition contains 0.01% by mass or more and 3.0% by mass or less of a wing wetting agent having a surface tension at 25° C. of 27.0 mN/m or more and 50.0 mN/m or less as a 3 mmol/kg aqueous solution and further contains 80% by mass or more and 99.99% by mass or less of water, the composition being used by being sprayed in the form of droplets having an average particle diameter of 20 μm or more and 400 μm or less.
   <31>

A flying pest exterminating spray including a flying pest exterminating composition filled in a spray container, wherein
the composition contains 0.01% by mass or more and 3.0% by mass or less of a wing wetting agent having a surface tension at 25° C. of 27.0 mN/m or more and 50.0 mN/m or less as a 3 mmol/kg aqueous solution and further contains 80% by mass or more and 99.99% by mass or less of water, and the content of a (meth)acrylic acid alkyl ester copolymer in the composition is 0.05% by mass or less, the composition being used by being sprayed in the form of droplets having an average particle diameter of 20 μm or more and 400 μm or less.
   <32>

A flying pest exterminating spray including a flying pest exterminating composition filled in a spray container, wherein
the composition has a surface tension at 25° C. of 27.0 mN/m or more and 50.0 mN/m or less, contains 0.01% by mass or more and 3.0% by mass or less of a wing wetting agent, and further contains 80% by mass or more and 99.99% by mass or less of water, and the content of a (meth)acrylic acid alkyl ester copolymer in the composition is 0.05% by mass or less, the composition being used by being sprayed in the form of droplets having an average particle diameter of 20 μm or more and 400 μm or less.
   <33>

A flying pest exterminating spray including a flying pest exterminating composition filled in a spray container, wherein
the composition contains a (meth)acrylic acid alkyl ester copolymer, contains 0.01% by mass or more and 0.80% by mass or less of a wing wetting agent having a surface tension at 25° C. of 27.0 mN/m or more and 50.0 mN/m or less as a 3 mmol/kg aqueous solution, and further contains 80% by mass or more and 99.99% by mass or less of water, the composition being used by being sprayed in the form of droplets having an average particle diameter of 20 μm or more and 400 μm or less.
   <34>

A flying pest exterminating spray including a flying pest exterminating composition filled in a spray container, wherein
the composition has a surface tension at 25° C. of 27.0 mN/m or more and 50.0 mN/m or less, contains a (meth)acrylic acid alkyl ester copolymer, contains 0.01% by mass or more and 0.80% by mass or less of a wing wetting agent, and further contains 80% by mass or more and 99.99% by mass or less of water, the composition being used by being sprayed in the form of droplets having an average particle diameter of 20 μm or more and 400 μm or less.
   <35>

A flying pest exterminating spray including a flying pest exterminating composition filled in a trigger spray type container having no foam forming mechanism, wherein
the composition contains 0.01% by mass or more and 3.0% by mass or less of a wing wetting agent having a surface tension at 25° C. of 27.0 mN/m or more and 50.0 mN/m or less as a 3 mmol/kg aqueous solution and further contains 80% by mass or more and 99.99% by mass or less of water, the composition being used by being sprayed in the form of droplets having an average particle diameter of 20 μm or more and 400 μm or less.
   <36>

A flying pest exterminating spray including a flying pest exterminating composition filled in a trigger spray type container having no foam forming mechanism, wherein
the composition has a surface tension at 25° C. of 27.0 mN/m or more and 50.0 mN/m or less, contains 0.01% by mass or more and 3.0% by mass or less of a wing wetting agent, and further contains 80% by mass or more and 99.99% by mass or less of water, the composition being used by being sprayed in the form of droplets having an average particle diameter of 20 μm or more and 400 μm or less.
   <37>

The spray as set forth in any one of <27> to <36>, wherein the surface tension at 25° C. of a 3 mmol/kg aqueous solution of the wing wetting agent is 27.0 mN/m or more and 50.0 mN/m or less, and it is preferably 27.5 mN/m or more, more preferably 28.0 mN/m or more, still more preferably 29.0 mN/m or more, and yet still more preferably 29.5 mN/m or more, and preferably 45.0 mN/m or less, more preferably 40.0 mN/m or less, still more preferably 33.0 mN/m or less, and yet still more preferably 31.0 mN/m or less.

<38>

The spray as set forth in any one of <27> to <32> and <35> to <37>, wherein the content of the wing wetting agent in the composition is preferably 0.02% by mass or more, more preferably 0.05% by mass or more, still more preferably 0.08% by mass or more, and yet still more preferably 0.10% by mass or more, and preferably 2.0% by mass or less, more preferably 1.0% by mass or less, still more preferably 0.80% by mass or less, yet still more preferably 0.55% by mass or less, and even yet still more preferably 0.40% by mass or less.

<39>

The spray as set forth in any one of <27> to <38>, wherein an average particle diameter of the droplets is preferably 30 μm or more, and more preferably 50 μm or more, and preferably 300 μm or less, more preferably 200 μm or less, and still more preferably 170 μm or less.

<40>

The spray as set forth in any one of <27> to <39>, wherein an ejection orifice diameter of the spray container is preferably 0.1 mm or more, and more preferably 0.3 mm or more, and preferably 1.5 mm or less, and more preferably 1.0 mm or less.

<41>

The spray as set forth in any one of <27> to <34> and <37> to <40>, wherein the spray container is a trigger spray type container, and preferably an accumulation type trigger spray container.

<42>

The spray as set forth in <41>, wherein the trigger spray type container is a trigger spray type container having no foam forming mechanism.

<43>

The spray as set forth in <35>, <36>, <41>, or <42>, wherein the discharge amount of the composition by the trigger spray type container is preferably 0.2 g/time or more, more preferably 0.5 g/time or more, and still more preferably 0.7 g/time or more, and preferably 2.0 g/time or less, more preferably 1.5 g/time or less, and still more preferably 1.2 g/time or less in terms of a discharge amount per one time of trigger operation.

<44>

The spray as set forth in any one of <27> to <43>, wherein the surface tension at 25° C. of the composition is 27.0 mN/m or more, preferably 27.5 mN/m or more, more preferably 28.0 mN/m or more, still more preferably 29.0 mN/m or more, and yet still more preferably 29.5 mN/m or more, and it is 50.0 mN/m or less, preferably 45.0 mN/m or less, more preferably 40.0 mN/m or less, still more preferably 33.0 mN/m or less, and yet still more preferably 31.0 mN/m or less.

<45>

An extermination method of flying pests, including spraying a composition containing 0.01% by mass or more and 3.0% by mass or less of a wing wetting agent having a surface tension at 25° C. of 27.0 mN/m or more and 50.0 mN/m or less as a 3 mmol/kg aqueous solution and further containing 80% by mass or more and 99.99% mass or less as droplets having an average particle diameter of 20 μm or more and 400 μm or less to bring into contact with wings of a flying pest.

<46>

An extermination method of flying pests, including spraying a composition having a surface tension at 25° C. of 27.0 mN/m or more and 50.0 mN/m or less, containing 0.01% by mass or more and 3.0% by mass or less of a wing wetting agent, and further containing 80% by mass or more and 99.99% by mass or less of water as droplets having an average particle diameter of 20 μm or more and 400 μm or less to bring into contact with wings of a flying pest.

<47>

The method as set forth in <45> or <46>, wherein the surface tension at 25° C. of a 3 mmol/kg aqueous solution of the wing wetting agent is 27.0 mN/m or more and 50.0 mN/m or less, and it is preferably 27.5 mN/m or more, more preferably 28.0 mN/m or more, still more preferably 29.0 mN/m or more, and yet still more preferably 29.5 mN/m or more, and preferably 45.0 mN/m or less, more preferably 40.0 mN/m or less, still more preferably 33.0 mN/m or less, and yet still more preferably 31.0 mN/m or less.

<48>

The method as set forth in any one of <45> to <47>, wherein the content of the wing wetting agent in the composition is preferably 0.02% by mass or more, more preferably 0.05% by mass or more, still more preferably 0.08% by mass or more, and yet still more preferably 0.10% by mass or more, and preferably 2.0% by mass or less, more preferably 1.0% by mass or less, still more preferably 0.80% by mass or less, yet still more preferably 0.55% by mass or less, and even yet still more preferably 0.40% by mass or less.

<49>

The method as set forth in any one of <45> to <48>, wherein an average particle diameter of the sprayed droplets is 20 μm or more, preferably 30 μm or more, and more preferably 50 μm or more, and preferably 300 μm or less, more preferably 200 μm or less, and still more preferably 170 μm or less.

<50>

The method as set forth in any one of <45> to <49>, wherein the flying pest is a mosquito.

### EXAMPLES

The present invention is hereunder described by reference to Examples, but that the present invention is not limited to the scope of the Examples. In the present Examples, various measurements and evaluations were performed by the following methods.

### (Surface Tension)

The surface tension was measured in the environment at 25° C. by the Wilhelmy method. With respect to respective wetting agents described in Table 1, one obtained by dissolving each wetting agent in water to prepare an aqueous solution having a concentration of 3 mmol/kg was used as a measurement sample. With respect to a flying pest exterminating composition described of each of the Examples, the foregoing composition was used as it was as a measurement sample. These measurement samples were each poured into a glass-made Petri dish having a diameter of 6.4 cm and a depth of 3.8 cm, and after removing air bubbles on the water surface, the measurement was performed in the state that the resulting sample was allowed to stand still for 30 minutes or more. In the present measurement, using a surface tension balance “K100” (manufactured by KRÜSS GmbH), a platinum plate was kept immersed in the aforementioned aqueous solution in a depth of 1 mm, and a measured value 10 minutes after the immersion was taken as a value of the surface tension.

### (Contact Angle Against Wings of Mosquito)

Wings of Aedes albopictus (female) were collected, and 8 to 10 pieces of the collected wings were arranged without generating gaps on a double-sided tape (“NITTO TAPE”, manufactured by Nitto Denko Corporation).

Using a contact angle meter “DMo-501” (manufactured by Kyowa Interface Science Co., Ltd.), 0.5 μL of a 3 mmol/kg aqueous solution of the wing wetting agent was dropped on the wings in the environment at 25° C., and a contact angle one second after dropping was measured by the θ/2 method.

### (Kinematic Viscosity)

The kinematic viscosity was measured using an Ubbelohde viscometer (kinematic viscosity measurement range: 0.6 to 3.0 mm²/s). The sample was put into the viscometer so as to not generating bubbling, and the aforementioned viscometer was installed vertically in a thermostat.

In addition, the sample within the viscometer during the measurement was set such that the distance from the liquid level in the thermostat and the inner wall of the thermostat was 20 mm in every part. The sample was allowed to stand still until it reached a temperature of 25° C.; after it reached 25° C., the sample was allowed to naturally drop; an outflow time for which a meniscus of the sample passed between predetermined marked lines was measured; and the kinematic viscosity was calculated by multiplying the measured time by the constant inherent to the viscometer.

### (Volume Particle Diameter Distribution and Volume Median Particle Diameter (D50) of Sprayed Droplets)

The volume particle diameter distribution and the volume median particle diameter (D50) of the sprayed droplets were measured at room temperature (25° C.) using a Spraytec laser diffraction system (Model No. STP5921, manufactured by Malvern Panalytical Instrument) by the laser diffraction method. The spray having the composition of each of the Examples filled in the spray container was placed such that the tip of the spray nozzle of the spray container was located at a position of 15 cm in terms of a horizontal distance until a measurement area of the laser diffraction system, the trigger operation was performed one time to spry the composition, and the volume particle diameter distribution of the sprayed droplets detected in the measurement area having a laser length of 34 cm and a laser width of 1.8 cm was measured. A value of the volume median particle diameter (D50) was taken as the average particle diameter of the sprayed droplets. A measurement range of the volume particle diameter distribution was set to 0.1 to 2,000 μm.

In the aforementioned trigger operation, the trigger was pulled with a full stroke. A trigger operation time (time from the start of pulling the trigger to the end of pulling) was 0.2 to 0.5 seconds, a liquid discharge time (time from the start of discharge to the end of discharge in the liquid) was 0.2 to 0.3 seconds, and a discharge speed ((discharge amount)/(liquid discharge time)) was 3.0 to 4.5 g/s.

### (Number of Dropped Mosquitoes at Spray Distance of 30 cm)

The evaluation method of the number of dropped mosquitoes at a spray distance of 30 cm is explained using FIGS. 1 and 2. FIG. 1 is a planar schematic view of a frame (1) used for the evaluation of the number of dropped mosquitoes, in which mosquitoes were enclosed; and FIG. 2 is a schematic view in which the state of spraying the flying pest exterminating composition within the frame (1) was seen from the side direction of the frame (1).

As shown in FIG. 1, 10 mosquitoes (2) (adult Aedes albopictus) were placed in a plastic-made frame (1) with an aspect ratio of 6 cm×6 cm and a depth of 4 cm, and a front face (11) and a rear face (12) of the frame (1) were covered by a mesh net (3) having a wire diameter of 0.1 mm and an opening of 1 mm, thereby enclosing the mosquitoes therein.

Subsequently, as shown in FIG. 2, a spray having the composition of each of the Examples filled in a spray container (4) was fixed at a position where a horizontal distance d until the front face (11) of the frame (1) having the mosquitoes (2) charged therein was 30 cm such that the tip of the spray nozzle (that is, the ejection port) (41) of the spray container (4) reached, and the trigger operation was performed one time toward the inside of the frame (1) to spray the composition. A symbol (5) in FIG. 2 is a sprayed composition.

After 30 seconds, the condition of mosquitoes (2) was observed, and the number of mosquitoes that could not fly was counted. This work was repeated three times, and an average value of the number of mosquitoes that could not fly was taken as the number of dropped mosquitoes.

### (Reach Amount of Sprayed Droplets)

A spray in which a 3 mmol/kg aqueous solution of the wetting agent shown in Table 1 was filled in a spray container A shown in Table 2 was prepared.

In the evaluation method described in the preceding section, one in which instead of the mesh net (3), a paper towel (“Kim Towel White”, manufactured by Nippon Paper Crecia Co., Ltd.) cut into a size of 6 cm×6 cm was stuck to the front face (11) of the frame (1) with a double-sided tape was prepared. Before the evaluation, the total weight of the frame (1) and the paper towel was measured, and then, the spray was fixed at a position where the horizontal distance d until the front face (11) of the frame (1) was 30 cm such that the tip of the spray nozzle (that is, the ejection port) (41) of the spray container (4) reached, and the trigger operation was performed five times toward the inside of the frame (1) to spray the aqueous solution. After spraying, the weights of the frame (1) and the paper towel were measured, and a reach amount of the sprayed droplets per spraying was calculated according to the following calculation equation.

(Reach amount of sprayed droplets (mg/cm² per time)={(Weights of frame and paper towel after spraying)−(Weights of frame and paper towel before spraying)}/(Area (36 cm²) of paper towel)/(Spraying time (five times))

It can be judged that the wetting agent is one in which the larger the reach amount of sprayed droplets, the higher the straightness of the spray droplets when used for the flying pest exterminating composition, and the more excellent the action of capable of efficiently reaching the flying pests.

### (Evaluation of Stickiness)

A 6.5 cm square tile was erected vertically on the ground, a spray having the composition of each of the Examples filled in a spray container was placed at a position where a horizontal distance until the tile face was 30 cm such that the tip of the spray nozzle (ejection port) of the spray container, and the trigger operation was performed one time to spray the composition, followed by performing natural drying.

Four skilled researchers evaluated a sticky feeling when the sprayed surface of the tile was touched by fingers according to the following criteria, and an average score thereof was calculated.

### <Evaluation Criteria>

4: Not sticky at all
3: Slightly sticky
2: Considerably sticky
1: Very sticky and felt adhesiveness

### Examples 1 to 21 and Comparative Examples 1 to 9 (Preparation and Evaluation of Flying Pest Exterminating Composition)

A wetting agent and a film-formable polymer shown in Table 1 and a spray container shown in Table 2 were prepared.

Respective components used for the flying pest exterminating composition were blended and mixed in blending amounts shown in Tables 3 to 6 to prepare flying pest exterminating compositions. The composition was filled in an amount of 300 to 370 mL according to the capacity of the spray container shown in the table to fabricate a flying pest exterminating spray. The blending amounts shown in Tables 3 to 6 are each the amount of the active ingredient (% by mass) of each component. In addition, as a spray container E used in Comparative Example 9, a container in which the average particle diameter of the sprayed droplets was smaller than 20 μm was used.

Using the obtained flying pest exterminating spray, various evaluations were performed by the aforementioned methods. The evaluation results are shown in Tables 3 to 6. In each of the tables, the surface tension at 25° C. of a 3 mmol/kg aqueous solution of the wetting agent is expressed simply as “25° C. surface tension”.

TABLE 1

| | | | | | | | | Contact | | |
|---|---|---|---|---|---|---|---|---|---|---|
| | | | | | Average | | | angle | | Reach amount of |
| | | | | | EO | | 25° C. | against | | sprayed droplets |
| | | | Product name | | addition | | surface | wing of | | of 3 mmol/kg |
| | Compound name or | | (name of | Alkyl | molar | Molecular | tension | mosquito | | aqueous solution |
| | INCI name | | manufacturer) | group | number | weight | [mN/m] | [°] | HLB | [mg/cm²] |
| Wing | a | Polyoxyethylene(5) lauryl | EMULGEN 106 | Lauryl | 4.6 | 388.98 | 27.34 | 38.6 | 10.5 | 0.5 |
| wetting | | ether | (Kao Corporation) | | | | | | | |
| agent | b | C10-C14 alkyl glucoside | MYDOL 12 | Lauryl | — | 383.10 | 29.61 | 55.0 | 12.1 | 1.7 |
| | | | (Kao Corporation) | | | | | | | |
| | c | Polyoxyethylene(9) lauryl | EMULGEN 109P | Lauryl | 8.3 | 551.98 | 31.82 | 64.8 | 13.6 | 2.4 |
| | | ether | (Kao Corporation) | | | | | | | |
| | d | Polyoxyethylene(12) lauryl | EMULGEN 120 | Lauryl | 13.2 | 767.84 | 36.09 | 71.9 | 15.3 | 2.6 |
| | | ether | (Kao Corporation) | | | | | | | |
| | e | 2-Ethylhexyl glyceryl ether | PENETOL GE-EH | 2- | — | 204.31 | 38.30 | 79.1 | 7.3 | 1.7 |
| | | | (Kao Corporation) | Ethylhexyl | | | | | | |
| | f | Polyoxyethylene(19) lauryl | EMULGEN 147 | Lauryl | 18.5 | 1001.32 | 42.13 | 113.8 | 16.3 | 3.2 |
| | | ether | (Kao Corporation) | | | | | | | |
| | g | Sodium lauryl sulfate | EMAL 0 | Lauryl | — | 288.38 | 29.20 | 111.0 | — | 5.7 |
| | | | (Kao Corporation) | | | | | | | |
| | h | Benzalkonium chloride | SANISOL B-50 | Liner | — | 339.50 | 32.68 | 80.0 | — | 3.1 |
| | | | (Kao Corporation) | C12-16 | | | | | | |
| Wetting | i | Polyoxyethylene(3) lauryl | EMULGEN 103 | Lauryl | 2.9 | 314.09 | 26.13 | 54.0 | 8.1 | 0.2 |
| agent for | | ether | (Kao Corporation) | | | | | | | |
| comparison | j | Polyoxyethylene(47) lauryl | EMULGEN 150 | Lauryl | 47 | 2256.84 | 50.54 | 116.4 | 18.4 | 6.1 |
| | | ether | (Kao Corporation) | | | | | | | |
| Film- | k | N-Methacryloyloxyethyl | UKA FORMER | — | — | — | — | — | — | — |
| formable | | N,N-dimethylammonium- | R205S | | | | | | | |
| polymer | | α-N-methylcarboxybetaine- | (Mitsubishi | | | | | | | |
| | | methacrylic acid alkyl ester | Chemical | | | | | | | |
| | | copolymer | Corporation) | | | | | | | |

| | | | | | | | | | |
|---|---|---|---|---|---|---|---|---|---|
| Water | — | — | — | — | — | 72.73 | 131.1 | — | — |

TABLE 2

| | | | | | | Ejection orifice | Discharge |
|---|---|---|---|---|---|---|---|
| | | | | Foam forming | Capacity | diameter | amount |
| | | Kind | Trigger type | mechanism | [mL] | [mm] | [g/time] |
| Spray | A | Trigger spray | Accumulation | No | 370 | 0.8 | 0.88 |
| container | | type | type | | | | |
| | B | Trigger spray | Accumulation | No | 370 | 0.15 | 0.88 |
| | | type | type | | | | |
| | C | Trigger spray | Accumulation | No | 370 | 1 | 0.88 |
| | | type | type | | | | |
| | D | Trigger spray | Accumulation | Yes | 300 | 0.5 | 0.73 |
| | | type | type | | | | |

TABLE 3

| | | | | | Contact | | | | | | | | | | |
|---|---|---|---|---|---|---|---|---|---|---|---|---|---|---|---|
| | | | | | angle | | | | | | | | | | |
| | | | | 25° C. | against | | | | | | | | | | |
| | | | | surface | wing of | | | | | | | | | | |
| | | | | tension | mosquito | Example | | | | | | | | | |
| | | | | [mN/m] | [°] | 1 | 2 | 3 | 4 | 5 | 6 | 7 | 8 | 9 | 10 |
| Composition | Wing | a | Polyoxyethylene(5) | 27.34 | 38.6 | 0.10 | | | | | | | | | |
| blend | wetting | | lauryl ether | | | | | | | | | | | | |
| (% by mass) | agent | b | C10-C14 alkyl | 29.61 | 55.0 | | 0.10 | | | | | 0.01 | 0.30 | 0.50 | 0.70 |
| | | | glucoside | | | | | | | | | | | | |
| | | c | Polyoxyethylene(9) | 31.82 | 64.8 | | | 0.10 | | | | | | | |
| | | | lauryl ether | | | | | | | | | | | | |
| | | d | Polyoxyethylene(12) | 36.09 | 71.9 | | | | 0.10 | | | | | | |
| | | | lauryl ether | | | | | | | | | | | | |
| | | e | 2-Ethylhexyl glyceryl | 38.30 | 79.1 | | | | | 0.10 | | | | | |
| | | | ether | | | | | | | | | | | | |
| | | f | Polyoxyethylene(19) | 42.13 | 113.8 | | | | | | 0.10 | | | | |
| | | | lauryl ether | | | | | | | | | | | | |
| | | g | Sodium lauryl sulfate | 29.20 | 111.0 | | | | | | | | | | |
| | | h | Benzalkonium chloride | 32.68 | 80.0 | | | | | | | | | | |
| | Wetting | i | Polyoxyethylene(3) | 26.13 | 54.0 | | | | | | | | | | |
| | agent for | | lauryl ether | | | | | | | | | | | | |
| | comparison | j | Polyoxyethylene(47) | 50.54 | 116.4 | | | | | | | | | | |
| | | | lauryl ether | | | | | | | | | | | | |
| | Film- | k | N-Methacryloyloxy- | — | — | | | | | | | | | | |
| | formable | | ethyl N,N-dimethyl- | | | | | | | | | | | | |
| | polymer | | ammonium-α-N- | | | | | | | | | | | | |
| | | | methylcarboxy- | | | | | | | | | | | | |
| | | | betaine-methacrylic | | | | | | | | | | | | |
| | | | acid alkyl ester | | | | | | | | | | | | |
| | | | copolymer | | | | | | | | | | | | |

| | | | | | | | | | | | | |
|---|---|---|---|---|---|---|---|---|---|---|---|---|
| Water | 72.73 | 131.1 | 99.90 | 99.90 | 99.90 | 99.90 | 99.90 | 99.90 | 99.99 | 99.70 | 99.50 | 99.30 |

| Surface tension at 25° C. of composition [mN//m] | | 27.4 | 29.4 | 31.9 | 36.2 | 37.2 | 42.2 | 29.7 | 29.7 | 29.8 | 29.9 |
|---|---|---|---|---|---|---|---|---|---|---|---|
| Kinematic viscosity at 25° C. of composition [mm²/s] | | 0.93 | 0.92 | 0.91 | 0.91 | 0.90 | 0.91 | 0.92 | 0.94 | 0.95 | 0.96 |
| Spray container | | A | A | A | A | A | A | A | A | A | A |
| Evaluation | Average particle diameter of sprayed droplets [μm] | 71.6 | 75.7 | 73.3 | 74.2 | 75.7 | 77.3 | 75.4 | 74.9 | 74.7 | 74.3 |
| results | Proportion of sprayed droplets having a particle diameter | 0 | 0 | 0 | 0 | 0 | 0 | 0 | 0 | 0 | 0 |
| | of 10 μm or less [%] | | | | | | | | | | |
| | Proportion of sprayed droplets having a particle diameter | 2.5 | 0.7 | 0.6 | 0.5 | 0.2 | 0 | 0.3 | 0.4 | 2.6 | 2.7 |
| | of 30 μm or less [%] | | | | | | | | | | |
| | Proportion of sprayed droplets having a particle diameter | 0 | 0 | 0 | 0 | 0 | 0 | 0 | 0 | 0 | 0 |
| | of 300 μm or more [%] | | | | | | | | | | |
| | Proportion of sprayed droplets having a particle diameter | 0 | 0 | 0 | 0 | 0 | 0 | 0 | 0 | 0 | 0 |
| | of 500 μm or more [%] | | | | | | | | | | |
| | Number of dropped mosquitoes at a spray distance of 30 cm | 7.3 | 9.7 | 8.7 | 8.3 | 8.7 | 7.0 | 6.0 | 9.7 | 10.0 | 10.0 |
| | Stickiness evaluation | 4 | 4 | 4 | 4 | 4 | 4 | 4 | 4 | 3 | 2 |

TABLE 4

| | | | | 25° C. | Contact angle | | | | | | | | |
|---|---|---|---|---|---|---|---|---|---|---|---|---|---|
| | | | | surface | against wing | | | | | | | | |
| | | | | tension | of mosquito | Example | | | | | | | |
| | | | | [mN/m] | [°] | 11 | 12 | 13 | 14 | 15 | 16 | 17 | 18 |
| Composition | Wing | a | Polyoxyethylene(5) lauryl ether | 27.34 | 38.6 | | | | | | | | |
| blend | wetting | b | C10-C14 alkyl glucoside | 29.61 | 55.0 | | | | | | | | |
| (% by mass) | agent | c | Polyoxyethylene(9) lauryl ether | 31.82 | 64.8 | 0.01 | 0.30 | 0.50 | 0.70 | | | 0.50 | 0.70 |
| | | d | Polyoxyethylene(12) lauryl ether | 36.09 | 71.9 | | | | | | | | |
| | | e | 2-Ethylhexyl glyceryl ether | 38.30 | 79.1 | | | | | | | | |
| | | f | Polyoxyethylene(19) lauryl ether | 42.13 | 113.8 | | | | | | | | |
| | | g | Sodium lauryl sulfate | 29.20 | 111.0 | | | | | 0.10 | | | |
| | | h | Benzalkonium chloride | 32.68 | 80.0 | | | | | | 0.10 | | |
| | Wetting | i | Polyoxyethylene(3) lauryl ether | 26.13 | 54.0 | | | | | | | | |
| | agent for | j | Polyoxyethylene(47) lauryl ether | 50.54 | 116.4 | | | | | | | | |
| | comparison | | | | | | | | | | | | |
| | Film- | k | N-Methacryloyloxyethyl N,N- | — | — | | | | | | | 0.04 | 0.04 |
| | formable | | dimethylammonium-α-N- | | | | | | | | | | |
| | polymer | | methylcarboxybetaine- | | | | | | | | | | |
| | | | methacrylic acid alkyl ester | | | | | | | | | | |
| | | | copolymer | | | | | | | | | | |

| | | | | | | | | | | |
|---|---|---|---|---|---|---|---|---|---|---|
| Water | 72.73 | 131.1 | 99.99 | 99.70 | 99.50 | 99.30 | 99.90 | 99.90 | 99.46 | 99.26 |

| Surface tension at 25° C. of composition [mN//m] | | 31.8 | 32.0 | 31.9 | 32.1 | 29.1 | 32.9 | 31.8 | 31.7 |
|---|---|---|---|---|---|---|---|---|---|
| Kinematic viscosity at 25° C. of composition [mm²/s] | | 0.91 | 0.93 | 0.94 | 0.95 | 0.90 | 0.92 | 0.95 | 1.00 |
| Spray container | | A | A | A | A | A | A | A | A |
| Evaluation | Average particle diameter of sprayed droplets [μm] | 78.1 | 77.8 | 76.5 | 76.1 | 75.2 | 75.3 | 80.2 | 81.7 |
| results | Proportion of sprayed droplets having a particle diameter | 0 | 0 | 0 | 0 | 0 | 0 | 0 | 0 |
| | of 10 μm or less [%] | | | | | | | | |
| | Proportion of sprayed droplets having a particle diameter | 0.7 | 0.5 | 0.5 | 0.4 | 0 | 0.1 | 0 | 0 |
| | of 30 μm or less [%] | | | | | | | | |
| | Proportion of sprayed droplets having a particle diameter | 0 | 0 | 0 | 0 | 0 | 0 | 0 | 0 |
| | of 300 μm or more [%] | | | | | | | | |
| | Proportion of sprayed droplets having a particle diameter | 0 | 0 | 0 | 0 | 0 | 0 | 0 | 0 |
| | of 500 μm or more [%] | | | | | | | | |
| | Number of dropped mosquitoes at a spray distance of 30 cm | 5.3 | 9.7 | 10.0 | 10.0 | 6.0 | 8.7 | 10.0 | 10.0 |
| | Stickiness evaluation | 4 | 4 | 3 | 2 | 4 | 4 | 3 | 2 |

TABLE 5

| | | | | | Contact | | | | | | | | |
|---|---|---|---|---|---|---|---|---|---|---|---|---|---|
| | | | | | angle | | | | | | | | |
| | | | | 25° C. | against | | | | | | | | |
| | | | | surface | wing of | | | | | | | | |
| | | | | tension | mosquito | Comparative Example | | | | | | | |
| | | | | [mN/m] | [°] | 1 | 2 | 3 | 4 | 5 | 6 | 7 | 8 |
| Composition | Wing | a | Polyoxyethylene(5) lauryl | 27.34 | 38.6 | | | | | | | | |
| blend | wetting | | ether | | | | | | | | | | |
| (% by mass) | agent | b | C10-C14 alkyl glucoside | 29.61 | 55.0 | | | | 0.001 | | | | |
| | | c | Polyoxyethylene(9) lauryl | 31.82 | 64.8 | | | | | 0.001 | | | |
| | | | ether | | | | | | | | | | |
| | | d | Polyoxyethylene(12) lauryl | 36.09 | 71.9 | | | | | | | | |
| | | | ether | | | | | | | | | | |
| | | e | 2-Ethylhexyl glyceryl ether | 38.30 | 79.1 | | | | | | | | |
| | | f | Polyoxyethylene(19) lauryl | 42.13 | 113.8 | | | | | | | | |
| | | | ether | | | | | | | | | | |
| | | g | Sodium lauryl sulfate | 29.20 | 111.0 | | | | | | | | |
| | | h | Benzalkonium chloride | 32.68 | 80.0 | | | | | | | | |
| | Wetting | i | Polyoxyethylene(3) lauryl | 26.13 | 54.0 | | 0.10 | | | | | | |
| | agent for | | ether | | | | | | | | | | |
| | comparison | j | Polyoxyethylene(47) lauryl | 50.54 | 116.4 | | | 0.10 | | | | | |
| | | | ether | | | | | | | | | | |
| | Film- | k | N-Methacryloyloxyethyl N,N- | — | — | | | | | | 0.04 | 0.10 | 0.30 |
| | formable | | dimethylammonium-α-N- | | | | | | | | | | |
| | polymer | | methylcarboxybetaine- | | | | | | | | | | |
| | | | methacrylic acid alkyl ester | | | | | | | | | | |
| | | | copolymer | | | | | | | | | | |

| | | | | | | | | | | |
|---|---|---|---|---|---|---|---|---|---|---|
| Water | 72.73 | 131.1 | 100.00 | 99.90 | 99.90 | 99.999 | 99.999 | 99.96 | 99.90 | 99.70 |

| Surface tension at 25° C. of composition [mN//ml | | 72.7 | 25.8 | 46.3 | 42.0 | 44.0 | 54.3 | 53.7 | 50.1 |
|---|---|---|---|---|---|---|---|---|---|
| Kinematic viscosity at 25° C. of composition [mm²/s] | | 0.90 | 1.00 | 0.90 | 0.91 | 0.91 | 0.93 | 0.94 | 0.96 |
| Spray container | | A | A | A | A | A | A | A | A |
| Evaluation | Average particle diameter of sprayed droplets [μm] | 79.2 | 71.4 | 84.2 | 79.3 | 78.8 | 81.8 | 81.8 | 79.2 |
| results | Proportion of sprayed droplets having a particle diameter | 0 | 0.2 | 0 | 0 | 0 | 0 | 0 | 0 |
| | of 10 μm or less [%] | | | | | | | | |
| | Proportion of sprayed droplets having a particle diameter | 2 | 0.5 | 0 | 0.1 | 0.9 | 0 | 0 | 0 |
| | of 30 μm or less [%] | | | | | | | | |
| | Proportion of sprayed droplets having a particle diameter | 0 | 0 | 2.5 | 0 | 0 | 0 | 0 | 0 |
| | of 300 μm or more [%] | | | | | | | | |
| | Proportion of sprayed droplets having a particle diameter | 0 | 0 | 2.5 | 0 | 0 | 0 | 0 | 0 |
| | of 500 μm or more [%] | | | | | | | | |
| | Number of dropped mosquitoes at a spray distance of 30 cm | 0 | 0 | 3.7 | 0 | 0 | 0 | 0 | 0 |
| | Stickiness evaluation | 4 | 4 | 4 | 4 | 4 | 4 | 1 | 1 |

TABLE 6

| | | | | 25° C. | Contact angle | | | | | |
|---|---|---|---|---|---|---|---|---|---|---|
| | | | | surface | against wing | | | | | Comparative |
| | | | | tension | of mosquito | Example | | | | Example |
| | | | | [mN/m] | [°] | 2 | 19 | 20 | 21 | 9 |
| Composition | Wing wetting | b | C10-C14 alkyl glucoside | 29.61 | 55.0 | 0.10 | 0.10 | 0.10 | 0.10 | 0.10 |
| blend | agent | | | | | | | | | |

| | | | | | | | | |
|---|---|---|---|---|---|---|---|---|
| (% by mass) | Water | 72.73 | 131.1 | 99.90 | 99.90 | 99.90 | 99.90 | 99.90 |

| Spray container | | A | B | C | D | E |
|---|---|---|---|---|---|---|
| Evaluation | Average particle diameter (D50) of sprayed droplets [μm] | 75.7 | 28.1 | 157 | 296 | 16.6 |
| results | Proportion of sprayed droplets having a particle diameter of 10 μm or less [%] | 0 | 13.2 | 0.3 | 0 | 16.6 |
| | Proportion of sprayed droplets having a particle diameter of 30 μm or less [%] | 0.7 | 71.5 | 1.3 | 0 | 78.1 |
| | Proportion of sprayed droplets having a particle diameter of 300 μm or more [%] | 0 | 0 | 20.0 | 50.5 | 0 |
| | Proportion of sprayed droplets having a particle diameter of 500 μm or more [%] | 0 | 0 | 10.4 | 27.1 | 0 |
| | Number of dropped mosquitoes at a spray distance of 30 cm | 9.7 | 6.7 | 9.7 | 9.7 | 4.0 |
| | Stickiness evaluation | 4 | 4 | 4 | 2 | 4 |

From Tables 3 to 6, it is noted that in accordance with the flying pest exterminating composition of the present invention, an excellent effect for lowering the flying ability of mosquitoes that are a flying pest is revealed. Furthermore, the flying pest exterminating compositions of Examples 1 to 9, 11 to 13, 15 to 17, 19, and 20 in which the content of the wing wetting agent in the composition used is 0.55% by mass or less, and the average particle diameter of the sprayed droplets is 200 μm or less are less sticky after spraying on the tile, and therefore, they are able to suppress the stickiness to be caused due to attachment of the sprayed composition onto the surface to be sprayed and are favorable in handleability.

As the flying pest exterminating composition of the present invention, the following formulation can be prepared by the ordinary method.

### Formulation Example 1: Flying Pest Exterminating Composition

| | |
|---|---|
| Polyoxyethylene lauryl ether (EO addition molar | 0.40% by mass |
| number: 9) (*1): | |
| Fatty acid amidopropyl betaine (*2): | 0.05% by mass |
| 2-Propanol: | 5.0% by mass |
| 1,3-Butylene glycol: | 5.0% by mass |
| Propylene glycol: | 5.0% by mass |
| Fragrance: | 0.2% by mass |
| Purified water: | 84.35% by mass |
| Total: | 100% by mass |

(*1) EMALGEN 109P (manufactured by Kao Corporation)
(*2) Lauramidopropyl betaine, AMPHITOL 20AB (manufactured by Kao Corporation)

### INDUSTRIAL APPLICABILITY

In accordance with the present invention, it is possible to provide a flying pest exterminating composition and a flying pest exterminating spray, each of which has high safety for the human body and the environment and when sprayed on a flying pest, lowers the flying ability of the flying pest, thereby making it possible to efficiently exterminate the flying pest.

### REFERENCE SIGNS LIST

1: Frame
11: Front face of frame
12: Rear face of frame
2: Mosquito
3: Mesh net
4: Spray container
41: Tip of ejection nozzle (ejection port) of spray container
5: Flying pest exterminating composition sprayed

What is claimed is:

1. A flying pest exterminating composition comprising 0.01% by mass or more and 3.0% by mass or less of a wing wetting agent having a surface tension at 25° C. of 27.0 mN/m or more and 40.0 mN/m or less as a 3 mmol/kg aqueous solution, the composition being used by being sprayed in the form of droplets having an average particle diameter of 30 μm or more and 200 μm or less.

2. The flying pest exterminating composition according to claim 1, wherein the wing wetting agent includes a nonionic surfactant.

3. The flying pest exterminating composition according to claim 2, wherein the nonionic surfactant is at least one selected from the group consisting of a polyoxyalkylene alkyl ether, an alkyl glycoside, and an alkyl glyceryl ether.

4. The flying pest exterminating composition according to claim 1, wherein the composition contains 80% by mass or more and 99.99% by mass or less of water.

5. A flying pest exterminating composition comprising 0.01% by mass or more and 3.0% by mass or less of a wing wetting agent, the composition being used by being sprayed in the form of droplets having an average particle diameter of 30 μm or more and 200 μm or less and having a surface tension at 25° C. of 27.0 mN/m or more and 40.0 mN/m or less.

6. A flying pest exterminating spray comprising a flying pest exterminating composition filled in a spray container, wherein
the composition contains 0.01% by mass or more and 3.0% by mass or less of a wing wetting agent having a surface tension at 25° C. of 27.0 mN/m or more and 40.0 mN/m or less as a 3 mmol/kg aqueous solution, the composition being used by being sprayed in the form of droplets having an average particle diameter of 30 μm or more and 200 μm or less.

7. A flying pest exterminating spray comprising a flying pest exterminating composition filled in a spray container, wherein
the composition has a surface tension at 25° C. of 27.0 mN/m or more and 40.0 mN/m or less and contains 0.01% by mass or more and 3.0% by mass or less of a wing wetting agent, the composition being used by being sprayed in the form of droplets having an average particle diameter of 30 μm or more and 200 μm or less.
